(19) United States
(12) Patent Application Publication
(10) Pub. No.: US 2025/0328913 A1
(43) Pub. Date: Oct. 23, 2025

(54) Systems And Methods For Tracking Transactions For Engagement Platforms And Other Applications

(71) Applicant: Eric L Pankey, Duluth, GA (US)

(72) Inventor: Eric L Pankey, Duluth, GA (US)

(21) Appl. No.: 19/253,740

(22) Filed: Jun. 28, 2025

Related U.S. Application Data
(63) Continuation-in-part of application No. 18/974,614, filed on Dec. 9, 2024.
(60) Provisional application No. 63/608,208, filed on Dec. 9, 2023.

(51) Int. Cl. G06Q 30/01; G06Q 50/16

(52) U.S. Cl. CPC G06Q 30/01; G06Q 50/16

(57) ABSTRACT

Systems and methods are provided for tracking, managing, and analyzing transactions (e.g., real estate or other transactions) and other information from engagement platforms and other applications. Particular interfaces or dashboards are provided for each of the participants that are updated and provided with useful information in real-time, which can be used by human and/or artificial intelligence agents to enhance the particular application.

### CROSS REFERENCE TO RELATED APPLICATIONS

This application claims the benefit of U.S. Provisional Application Ser. No. 63/608,208, filed on Dec. 9, 2023, and U.S. Ser. No. 18/974,614, filed on Dec. 9, 2024, which are each hereby incorporated by reference herein in their entirety.

### FIELD OF THE INVENTION

The present invention relates to systems and methods for engagement platforms and similar applications. This can include generating structured engagement data from users (including anonymous users) and enhancing digital engagement platforms for human and/or artificial intelligence (AI) agents, and in certain embodiments using deterministic logic and AI integration. Certain embodiments provide a rules-based architecture that enables privacy-respecting, pre-identity personalization and AI training using declared user input rather than inferred behavior. In certain applications, the invention relates to human endeavor transaction management (e.g., engagement platforms) systems and methods, such as in the real estate industry.

### BACKGROUND OF THE INVENTION

Currently used engagement platforms and similar solutions and applications in different fields rely heavily on behavior tracking or premature identity capture to personalize user experiences and feed downstream systems such as CRMs or AI models. These systems and methods suffer from three key technical limitations:
1. Lack of Actionable Data Pre-Identity: Without user identification, most systems are unable to generate structured data, resulting in a blind spot during early engagement stages.
2. Privacy Risks from Behavioral Tracking: Behavior tracking technologies are imprecise, non-transparent, and often incompatible with existing and emerging data privacy regulations and concerns.
3. Inaccurate AI Training: AI systems trained on inferred or aggregated data fail to reflect the user's real-time intent, reducing relevance and performance.

For example, in today's rapidly progressing digital era, the real estate sector (an exemplary application used in this specification is the real estate sector as a non-limiting illustration) faces unique challenges. The heart of real estate, like many human endeavors, and other relevant industries has always been the personal touch, the human connection, and the irreplaceable wisdom that seasoned professionals bring to the table. Yet, the real estate sector, and other relevant sectors, does not seamlessly intertwine the systems and methods of technological advancements with the core values from the personal touch, the human connection, and expert and personalized service. Specific problems with current engagement platforms, systems and methods include information overload of the clients and others, lack of personalization to particular clients, lack of agent alignment with the others in their group, poor drivers for agent performance and services, poor integration of diverse services, poor and delayed feedback mechanisms, lack of client trust, overwhelming volumes of data, unreliable independent sources of advice, and the failure to empower agents with timely information and training. Thus, there is a need to invent technically advanced systems and methods to facilitate real estate and other relevant transactions, including providing for a personal touch, human connection, and expert and personalized services in the real estate sector, and other relevant industry sectors, that cannot be performed without the use of recent technological advancements as taught herein.

In addition, certain highly significant problems have not been adequately addressed, including a lack of anonymity, a lack of a personalized, useful and accurate experience, and the lack of efficient, seamless transitions, which led to failures in the process. There is a need to address these significant problems, among others. Better interactions with customers, employees, or members of a community in a meaningful and personalized way across various channels are needed, which may help foster stronger relationships, improve satisfaction, and drive desired outcomes by providing better communication, collaboration, and data analysis.

### SUMMARY OF THE INVENTION

This invention relates to new platforms, systems, and methods that facilitate complex client journeys and applications (e.g., engagement platforms, real estate transactions), including by providing a personal touch, human connection, and expert and personalized services. Aspects of the invention also include embodiments that generate structured user engagement data that can be consumed both by human agents and by machine systems, including artificial intelligence (AI) agents. The embodiments of the invention can be used to solve some or all of the problems of prior and current platforms, systems, and methods.

### Selected Examples of Objects and Aspects of the Invention

Objects of this invention include providing a new way of generating structured engagement data from anonymous users (e.g., potential clients, customers, buyers, interested parties) and enhancing digital engagement platforms and other applications for human and/or artificial intelligence (AI) agents, and in certain embodiments using deterministic logic and AI integration. Certain embodiments provide a rules-based architecture that enables privacy-respecting, pre-identity personalization and AI training using declared intent user input rather than inferred behavior. In certain applications, the invention relates to human endeavor transaction management (e.g., engagement platforms) systems and methods, such as in the real estate industry.

Thus, a core object and feature of many embodiments of this invention is the capturing of structured, compliant, intent-rich data from anonymous users. It is an object and feature of this invention that this data can then be used by different embodiments as “premium” human agent fuel and/or AI fuel. Therefore, these embodiments can be used by human agent systems and methods, AI agent systems and methods, or combinations of human agent and AI agent systems and methods.

These include systems and methods where the data is consumed exclusively by AI, automated decision-making or personalization powered by machine logic, and AI agents that initiate proactive workflows using declared intent, as examples. These also include how the structured, pre-identity engagement data can improve the ability of human agents to respond to the user, with or without the use of AI. However, each of these applications, whether directed to human agents, AI agents, or combinations of both, most preferably use the same underlying structured data approach.

It is an object of this invention and a feature that the invention is very flexible in how it can be applied to different applications or within applications. It includes a plurality of possible stages that are applied that may differ by application in the absolute number. However, in each of these applications, key innovations supplied by the invention, such as anonymity, personalized experience, and seamless transitions, are used, even if some steps are adjusted or removed in certain use cases. As an example, some engagement platform applications may or may not involve user-agent selection. Some embodiments may not provide the user with the ability to select or reject agents, while others may provide that ability.

Applications of this invention could include adding a choice to a user to “get personalized advice”, with no contact information required (i.e., for at least a time they remain anonymous, and, for example, a real estate agent does not automatically call them after they look at a listing). The user may be asked a few quick questions (e.g., goals, budget, timeline, preferences). From those responses, an embodiment of this invention may build a personalized dashboard, with links to content such as articles, videos, search capabilities, expert advice, insider secrets, additional serves, etc. Their clicks, interactions, what content they look at, for how long, and where they are in the journey, etc., or other similar data, provided by the user with the dashboard is captured by the embodiment and kept as “declared intent” data associated with a unique ID. This is then used as “premium” human agent fuel and/or AI fuel that was acquired without ever collecting the user's identification information, providing compliant information early unlike any current system or method. It is a smarter, safer, solution for enterprise AI and humans both. When and if the user provides identification information, the declared intent data can be linked up to them.

It is an important object of certain preferred embodiments that they establish a centralized repository that captures structured, deterministic data from users—including anonymous users who have not yet provided personal identity information. This data, based on declared user goals, preferences, and engagement behaviors, is organized according to predefined rules, enabling both human agents and/or AI systems to access, interpret, and act upon it.

A core feature of these preferred embodiments is the ability to generate a structured, auditable engagement history even when users remain anonymous. Each user is assigned a unique, non-identifying ID. The system captures declared inputs, content interactions, and engagement signals without the need for personal data.

Human agents can view anonymous user activity via their own dashboard, gaining insight into what content was accessed, how deeply users engaged, and what topics or actions show user readiness—all while maintaining user anonymity until voluntary identification occurs.

In addition to human access, certain embodiments of the invention allow structured user engagement data to be routed into automated systems, including machine learning models and AI agents. These systems can use the data to: (a) train models with clean, declared-intent engagement data, (b) score user readiness and likelihood of conversion, (c) recommend personalized next-best actions, (d) predict future user behaviors based on structured interaction patterns, (e) orchestrate proactive workflows even before a user submits contact information, and/or (f) other uses of data as set forth herein and that will be known to a person of skill in the art after reading this specification.

Because the engagement data is captured through deterministic logic—not inferred through behavioral tracking or probabilistic models—it offers auditable, compliant, and high-confidence input for both manual and automated systems.

Thus, these preferred embodiments of the invention provide a unified, privacy-centric, structured data stream that powers human judgment and intelligent automation alike—creating a foundational layer for more effective customer engagement and enterprise AI enablement.

### Certain Technical Advancements of Embodiments of This Invention

The embodiments of this invention provide technological solutions that improve the functioning of digital engagement platforms and other applications by enabling the structured, deterministic capture of user engagement data prior to identity submission—without reliance on behavioral tracking, probabilistic models, or invasive surveillance techniques. By introducing a rules-based system architecture that assigns anonymous identifiers and organizes declared user inputs into a structured, auditable format, these embodiments fundamentally enhance the ability of both human agents and automated systems to act on early-stage engagement. This improvement and added capability to data capture and system reliability solves a recognized technical problem in digital platforms and creates a new, privacy-compliant method of generating actionable intelligence, demonstrating that the invention is directed to a specific technological advancement rather than an abstract idea.

Additional technical advancements of embodiments of this invention are described throughout this specification. In certain embodiments in particular, this invention provides solutions for technological problems in engagement platforms (e.g., for real estate) and other applications. These can include customer engagement platforms, customer service and support, customer relationship management (CRM), employee engagement platforms, community engagement platforms, sales and/or marketing engagement platforms, student engagement platforms, donor engagement platforms, buyer engagement platforms, real estate engagement platforms, real estate relationship management platforms, and other possible applications. Such platforms may include a digital environment where a business or other organization can interact with individuals (e.g., clients, buyers, sellers, members) and interact, collaborate, connect, perform transactions, etc. Some platforms may enable businesses and other organizations to manage and optimize customer or member interactions, fostering meaningful relationships and driving desired outcomes. Some platforms may integrate multiple communication channels and offer features like personalized messaging, automation, and analytics.

Certain embodiments of this invention can solve the technological problems that exist in current systems such as (1) the lack of structured data from anonymous users, (2) the overreliance on behavioral tracking, (3) the inability to train AI systems using declared intent, (4) disconnected pre-and post-identity data streams, (5) CRM dependency on premature identity capture, and/or (6) generic content delivery without scenario context.

These embodiments of this invention solve these and other problems through a novel architecture that uses some or all of the following features, which comprise: (a) the creation and use of a rules-based decision engine to process declared input (e.g., user goals, timeline, budget) without requiring user identity information, (b) the creation and use of structured engagement data tied to an anonymous session ID, which can be transmitted to AI models for training and inference, (c) the creation and use of post-identity association, linking earlier structured activity with a CRM profile when the user later identifies themselves, (d) the creation and use of personalized content sequences that adapt based on scenario-specific rules—improving user experience and increasing conversion potential, and/or (e) the additional architecture and technical advancements set forth herein and those understood by persons of skill in the art, as well as in particular disclosed embodiments.

This approach provides a technological improvement to digital engagement and AI systems/methods by creating a compliant, auditable, and intelligent method for structuring early-stage user data. The systems/methods enhances both platform functionality and AI model fidelity without relying on invasive or abstract processes.

Key advantages and features of certain preferred embodiments comprise: (a) human and AI systems both consuming the structured engagement data, (b) anonymous users being captured in a compliant, deterministic way (no AI hallucination risk), (c) data being used for AI training, scoring, predicting, and orchestration—critical for ServiceNow/agentic AI framing, (d) auditability and compliance—important for regulated industries and other concerns, (e) full enablement—both human and machine embodiments are supported by these embodiments, and/or (f) other advantages set forth herein or that will be understood by a person of skill in the art reading the specification.

As set forth in this application, and addressed in part herein (e.g., below), this invention (a) addresses real technical problems in current systems and methods, (b) uses specific system logic to provide technical solutions to these problems, (c) improves existing systems and methods and their ability to engage, personalize and learn from users anonymously, and/or (d) includes inventive and concrete concepts beyond abstract data handling and/or business process automation.

For example, important preferred aspects of this invention are concrete and not abstract in that when it involves information processing, they do so in a new and specific manner that creates new metrics and tools and applies them in a way that has not been done before and which solve many of the limitations and problems that have plagued current systems and methods. They use a new architecture that results in concrete, functional improvements and capabilities for data collection and personalization systems and methods. This comprises use of some or all of the following new approaches: (a) creation of a 12-digit anonymized session ID incorporating date logic and randomization; (b) use of deterministic rules to personalize user engagement based on declared intent; (c) enabling optional session continuity via a password and visit date combination; and/or (d) avoiding the use of cookies, fingerprinting, or identity tracking entirely.

These preferred aspects of the invention also provide new practical applications to engagement platforms and other uses. They solve recognized technical challenges that have not been solved before, namely, how to personalize user engagement and collect structured AI-grade data (e.g., highly useful AI system and method inputs) before the user provides any identify information, without violating privacy laws or concerns. The solution provided therefore is not abstract or theoretical. It is operationally grounded, system-specific, and deployable across industries. The invention results in advantages and features that can include: (a) structured engagement data captured without identity, (b) cross-session continuity without storing client-side tokens, and/or (c) AI-ready data that improves enterprise automation and CRM performance. These outcomes reflect a practical application of deterministic logic to overcome limitations in existing web and CRM architectures.

In addition, these preferred aspects of the invention improve the functioning of technology. These embodiments improve data systems in three or more important ways that improve system and method performance, capabilities and functionality, and not just merely business process automation: (1) replaces tracking-based personalization with privacy-safe deterministic personalization, (2) eliminates reliance on cookies for continuity while preserving user state, and/or (3) creates new upstream data for AI and CRM systems before a user converts and, for example, supplies identity information.

Furthermore, these preferred aspects of the invention provide several inventive concepts. These can include (1) timestamp-encoded anonymized ID, (2) voluntary password-based session recovery without PII (personally identifiable information), (3) declarative logic for personalizing content, (4) real-time AI-compatible data structuring, and/or (5) additional concepts set forth herein or apparent from such concerning specific embodiments. These inventive concepts are not currently known, conventional, or routine. They reflect an inventive architecture with practical implementation, as shown in the disclosure and accompanying diagrams.

### Selected Embodiments for Illustration of General Application

In particularly preferred embodiments, computer-implemented systems and methods for generating and structuring engagement data from anonymous users to improve digital system performance is provided. The systems and methods can comprise (a) one or more memory devices storing rule definitions and engagement logic, and (b) one or more processors that are programmed. The programming can comprise one or more modules or capabilities to (i) receive declared input data from a user through a graphical interface, the input data comprising scenario-specific selections indicating information such as the user's goals, timeframe, or budget; (ii) identify a matched rule set from stored rule definitions corresponding to the declared input; (iii) assemble a sequence of digital content elements based on the matched rule set; (iv) assign an anonymous session identifier to the interaction; (v) generate a structured data record comprising the declared input, content engagement behavior, and associated timestamp data; (vi) store the structured data record in a persistent data store in a format optimized for machine learning ingestion; (vii) transmit the structured data record to an artificial intelligence model for training and inference, regardless of whether user identity has been captured; (viii) upon receipt of user identity, associate the structured data record with the corresponding CRM profile using a secure linking mechanism; and (ix) wherein the structured engagement data enables pre-identity personalization, improves AI model accuracy, and eliminates reliance on behavioral tracking systems, thereby enhancing the functional performance of the engagement platform. In certain specific embodiments of these systems and methods, the artificial intelligence system comprises a machine learning model configured to refine engagement recommendations based on aggregated, structured data from multiple anonymous user sessions, thereby enabling intent-aware optimization without requiring identity-based tracking.

In other particularly preferred embodiments, methods for improving artificial intelligence model performance using pre-identity user engagement data are provided. These methods comprise (a) receiving, via a digital interface, declared input data from a user who has not submitted identifying information; (b) processing the declared input data using a rules-based engine to determine a content sequence tailored to the user's stated scenario or need; (c) assigning a session-specific anonymous identifier to the user and logging structured records of the user's interaction with the content sequence; (d) transmitting the structured interaction data, linked only to the anonymous identifier, to an artificial intelligence system for use in model training or inference, such that the AI system learns from real declared-intent behavior without requiring identity or tracking-based data; (e) associating the structured data with the user's known profile to enrich CRM records and further refine AI models upon subsequent user identification; and (f) wherein the method improves AI training fidelity and personalization accuracy by enabling access to structured, declarative data captured before traditional lead conversion, without relying on probabilistic behavior tracking or invasive data collection.

### Exemplary Applications for Particular Transactions

Certain embodiments of this invention relate to new platforms, systems and methods that facilitate transactions (such as in real estate transactions), including by providing a personal touch, human connection, and expert and personalized services in the relevant sector. Aspects of this invention include embodiments that provide platforms, systems and methods for tracking transactions, as an illustration of how this invention can be applied to a specific problem.

The complexity of relevant transactions, combined with a multitude of stakeholders involved, has always presented significant challenges in terms of data management, communication, and user experience. In recent times, technological advancements have provided an avenue to overcome these challenges. The described platform herein, comprised of systems and methods, is a testament to how a cohesive blend of contemporary technologies can revolutionize the landscape of relevant (e.g., real estate transaction management).

Central to this platform is the establishment of a centralized repository. In a sector riddled with fragmented data sources, this unified database serves as the backbone, ensuring that all transactional data, be it from administrators, clients, or agents, converges into a single point of reference. This consolidation not only alleviates discrepancies but also reinforces data consistency and reliability.

The efficacy of this centralized approach is further bolstered by the system's ability to ensure real-time data synchronization. With numerous transactions occurring simultaneously, the ability to synchronize data in real-time is paramount. Through advanced integration mechanisms, the platform guarantees data concurrency, effectively eliminating the pitfalls of outdated information that can plague stakeholders.

A standout feature of the system is its adeptness at delivering a tailored user experience through Role-Based Access Control (RBAC). By discerning the specific role of a user, whether a client or an agent, the system seamlessly optimizes the user interface to their needs and permissions. This level of customization not only streamlines user interactions but also enhances overall system efficiency.

An intricate facet of real estate transactions, and other transactions, for example, is client management. The platform's Enhanced Client Management System (CMS) sets a new benchmark in this regard. By supporting detailed client profiling, the CMS ensures that all pertinent data, from personal details to transaction histories, is meticulously cataloged. Such an approach is pivotal in eradicating data redundancy and offering quick, actionable insights to agents.

Timely communication stands as a linchpin in real estate as well as other transactions. Addressing this, the platform incorporates an event-driven notification system. Utilizing an event-driven architecture (EDA), stakeholders receive prompt notifications for crucial events like offer submissions, drastically reducing response times and fostering efficient communication.

Matching clients with the right agents is often a herculean task, laden with subjectivity. The platform's Agent-Client Matching Algorithm used in certain embodiments heralds a paradigm shift in this domain. By leveraging specific criteria, it ensures optimal pairing, thereby augmenting user satisfaction and streamlining the transaction process.

Another cornerstone of the platform is its bifurcated (e.g., property) data handling mechanism. Recognizing the distinct needs of buyers and sellers, the system is adept at processing both buyer-centric and seller-centric data, thus ensuring all-encompassing transaction coverage.

To further elevate user experience, the platform presents a graphical transaction lifecycle visualization. This intuitive graphical representation elucidates transaction statuses, enabling stakeholders to gauge progress at a glance, a boon in a fast-paced environment.

In addition, the platform's robust data storage infrastructure is important. With data security and integrity at its core, this infrastructure, composed of fault-tolerant databases and servers, safeguards data while adhering to the highest standards of data protection.

This state-of-the-art platform exemplifies the transformative potential of technology in the realm of relevant transaction management. By addressing inherent challenges with cutting-edge solutions, it stands as a beacon of innovation, poised to reshape the industry for the better.

In particular, certain embodiments of this invention provide anonymity, personalized and more useful and accurate experiences, and/or seamless transitions, which were absent in proposed solutions of the past. Therefore, embodiments of this invention solve technical problems of the past that arise from a lack of anonymity, lack of personalized, useful and accurate experiences, and from complex and unsuccessful transitions that led to incomplete and failed processes.

Certain preferred embodiments of this invention provide methods for tracking a plurality of progressive relevant transaction steps in a client transaction. These methods comprise at least some of the following, such as (a) providing a system application server including a memory for storing processor instructions and a processor for executing the processor instructions; (b) providing a system session server, in communication with the system application server, the system session server configured to establish and maintain a system session with at least one user and generate at least one user interface accessible by the at least one user; (c) providing a user profile database in communication with the system application server, the user profile database including at least one client profile record including, (i) client personal information (e.g., contact information and/or open-access engagement tools (e.g., user input preferences, such as budget, location, property type, etc., instead of contact information; an anonymized data tracking code)), (ii) client interest (e.g., property or other subject of their interest) information, and (iii) client transaction step information corresponding to one of a plurality of progressive transaction steps in the client transaction; (d) providing a client user interface via the session server configured to display (i) the client personal information and/or open-access engagement tools, the (ii) client interest (e.g., property) information, and (iii) a plurality of transaction step indicia, wherein each of the plurality of transaction step indicia corresponds to the plurality of progressive transaction steps in the client transaction; (e) updating the client transaction step information in the client profile record to a subsequent client transaction step information corresponding to another one of the plurality of progressive transaction steps in the client transaction based on receiving one of (i) a system administration update, (ii) a client update via the client user interface, or (iii) a client agent update; and (f) updating the client user interface corresponding to updated subsequent client transaction step information by activating a corresponding one of the plurality of transaction step indicia in the client user interface. Some or all of the steps and/or actions addressed above can be impacted by the use of AI models, such as inputs based on the data that is collected.

In some embodiments of these methods, the client interest information comprises client buyer property information including client buyer target interest criteria. Also, in some of these embodiments, the client interest information comprises client seller interest information.

In some embodiments of these methods, the client transaction step information further includes one of: a proposed client agent notification; a client acceptance of a system-proposed client agent; a client rejection of a system-proposed client agent; a matched client agent notification; an offer submission notification; an offer received notification; a backup offer submission notification; a backup offer received notification; a rejected offer notification; a counteroffer submission notification; a counteroffer received notification; or an accepted offer notification.

In some embodiments of these methods, the plurality of transaction step indicia further includes one of: a proposed client agent notification indicium; a client acceptance of a system-proposed client agent indicium; a client rejection of a system-proposed client agent indicium; a matched client agent indicium; an offer submission indicium; an offer received indicium; a backup offer submission indicium; a backup offer received indicium; a rejected offer indicium; a counteroffer submission indicium; a counteroffer received indicium; or an accepted offer indicium.

In some embodiments of these methods, the system administration update corresponds to a process of matching a client agent to conduct the client transaction for a client.

In some embodiments of these methods, the client update corresponds to one of a client's rejection or a client's acceptance of a system-proposed client agent to conduct the client transaction for a client.

In some embodiments of these methods, the client agent update corresponds to one of the plurality of progressive transaction steps of the client transaction.

Certain preferred embodiments of this invention provide other methods for tracking a plurality of progressive transaction steps in a client transaction. The real estate subject matter of these embodiments that are described can be easily replaced with some other subject matter of interest from a different industry. These other methods comprise at least some of the following, such as (a) providing a system application server including a memory for storing processor instructions and a processor for executing the processor instructions; (b) providing a system session server, in communication with the system application server, the system session server configured to establish and maintain a system session with at least one user and generate at least one user interface accessible by the at least one user; (c) providing a user profile database, in communication with the system application server, the user profile database including at least one client profile record including (i) client personal information (e.g., contact information and/or open-access engagement tools (e.g., user input preferences, such as budget, location, property type, etc., instead of contact information; an anonymized data tracking code)), (ii) client interest information, and (iii) client transaction step information corresponding to one of a plurality of progressive transaction steps in a client transaction; (d) providing a client agent user interface configured to display (i) the client personal information, (ii) the client interest information, and (iii) a plurality of transaction step indicia, wherein each of plurality of transaction step indicia corresponds to the plurality of progressive transaction steps in the client transaction; (e) updating the client transaction step information in the client profile record to a subsequent client transaction step information corresponding to another one of the plurality of progressive transaction steps in the client transaction based on receiving a client agent update via the client agent user interface; and (f) updating the client agent user interface corresponding to the subsequent client transaction step information by activating a corresponding one of the plurality of transaction step indicia in the client agent user interface. Some or all of the steps addressed above can be impacted by the use of AI inputs based on the data that is collected.

In some embodiments of these other methods, the client interest information comprises client buyer property information including client buyer target property criteria.

In some embodiments of these other methods, the client interest information comprises client seller property information.

In some embodiments of these other methods, the client transaction step information further includes one of: a proposed client agent notification; a client acceptance of a system-proposed client agent; a client rejection of a system-proposed client agent; a matched client agent notification; an offer submission notification; an offer received notification; a backup offer submission notification; a backup offer received notification; a rejected offer notification; a counteroffer submission notification; a counteroffer received notification; or an accepted offer notification.

In some embodiments of these other methods, the plurality of transaction step indicia further includes one of: a proposed client agent notification indicium; a client acceptance of a system-proposed client agent indicium; a client rejection of a system-proposed client agent indicium; a matched client agent indicium; an offer submission indicium; an offer received indicium; a backup offer submission indicium; a backup offer received indicium; a rejected offer indicium; a counteroffer submission indicium; a counteroffer received indicium; or an accepted offer indicium.

In some embodiments of these other methods, the client agent update corresponds to one of the plurality of progressive transaction steps of the client transaction.

Certain embodiments of this invention provide systems for tracking a plurality of progressive transaction steps in a client transaction. These systems comprise at least some of the following, such as (a) a system application server including a memory for storing processor instructions and a processor for executing the processor instructions which when executed are configured to at least one of communicate with and control: (i) a system session server configured to establish and maintain a system session with at least one user and generate at least one user interface accessible by the at least one user; and (ii) a user profile database configured to store and update user profile records including a client profile record including (1) client personal information (e.g., contact information and/or open-access engagement tools (e.g., user input preferences, such as budget, location, property type, etc., instead of contact information; an anonymized data tracking code)), (2) client interest information, and (3) client transaction step information corresponding to one of a plurality of progressive transaction steps in a client transaction. Some or all of the steps addressed above can be impacted by the use of AI inputs based on the data that is collected.

These systems also comprise (b) wherein the system is configured to: (i) provide, by the system session server, a client user interface and a client agent user interface both configured to display (1) the client personal information, (2) the client interest information, and (3) a plurality of transaction step indicia, wherein each of the plurality of transaction step indicia corresponds to the plurality of progressive transaction steps in the client transaction; (ii) update, in the user profile database, the client transaction step information in the client profile record to a subsequent client transaction step information corresponding to another one of the plurality of progressive transaction steps in the client transaction based on receiving one of (1) a system administration update, (2) a client update via the client user interface, or (3) a client agent update via the client agent user interface; and (c) update, by the system session server, the client user interface and the client agent user interface corresponding to the subsequent client transaction step information by activating a corresponding one of the plurality of transaction step indicia in the client agent user interface.

In some embodiments of these systems, the client interest (e.g., property) information comprises client buyer interest information including client interest target property criteria.

In some embodiments of these systems, the client interest information comprises client seller interest information.

In some embodiments of these systems, the client (e.g., real estate) transaction step information further includes one of: a proposed client agent notification; a client acceptance of a system-proposed client agent; a client rejection of a system-proposed client agent; a matched client agent notification; an offer submission notification; an offer received notification; a backup offer submission notification; a backup offer received notification; a rejected offer notification; a counteroffer submission notification; a counteroffer received notification; or an accepted offer notification.

In some embodiments of these systems, the plurality of transaction step indicia further includes one of: a proposed client agent notification indicium; a client acceptance of a system-proposed client agent indicium; a client rejection of a system-proposed client agent indicium; a matched client agent indicium; an offer submission indicium; an offer received indicium; a backup offer submission indicium; a backup offer received indicium; a rejected offer indicium; a counteroffer submission indicium; a counteroffer received indicium; or an accepted offer indicium.

In some embodiments of these systems, the system administration update corresponds to a process of matching a client agent to conduct the client transaction for a client.

In some embodiments of these systems, the client update corresponds to one of a client's rejection or acceptance of a system-proposed client agent to conduct the client transaction for a client.

In some embodiments of these systems, the client agent update corresponds to one of the plurality of progressive transaction steps of the client transaction.

In certain of the most preferred embodiments of this invention, the platforms, systems and methods are flexible enough to accommodate implementations where users cannot select or reject particular agents.

These platforms, systems and methods may be provided on a computer-readable storage medium storing instructions that when executed by a computer cause the computer to perform a method for using a computer system to track transactions comprising the steps set forth above.

These platforms, systems and methods may also be provided on a memory for storing data for access by an application program being executed on a data processing system. This may comprise a data structure stored in the memory, the data structure including information resident in a database used by the application program and including a plurality of data objects configured to contain the information comprising that set forth above.

Advantages of the embodiments of this invention are described and apparent throughout this specification. Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description, figures, and appended claims.

### BRIEF DESCRIPTION OF THE DRAWINGS

FIG. 1 illustrates a schematic diagram of a preferred embodiment of a system disclosed herein.

FIG. 2 illustrates a schematic diagram of a time-based method of user interactions on multiple system user interfaces within the system and their interaction with a message database and a profile database.

FIG. 3 illustrates a schematic logical diagram of a method of creating an agent profile that will be stored in a profile database.

FIG. 4 illustrates an example of an agent profile that will be stored in a profile database.

FIG. 5 illustrates a schematic logical diagram of an embodiment of a method of creating both a buyer client profile record and a seller client profile record that will be stored in a profile database.

FIG. 6 illustrates a schematic logical diagram of a method of determining and assigning a current market rating value for a buyer client within the schematic logical diagram of the method of creating the buyer client profile record of FIG. 5.

FIG. 7 illustrates a schematic logical diagram of a method of determining and assigning a current market trend value for either a buyer client or a seller client within the schematic logical diagram of the method of creating both the buyer profile record and the seller profile record of FIG. 5.

FIG. 8 illustrates a schematic logical diagram of a method of determining and assigning a current market rating value for a seller client within the schematic logical diagram of the method of creating the seller client profile of FIG. 5.

FIG. 9 illustrates an embodiment of a continuation of the schematic logical diagram of the method of creating both the buyer profile record and the seller profile record that will be stored in the profile database of FIG. 5. In open-access engagement tools of certain embodiments of this invention, some personal information (e.g., contact information) is not collected at initial stages, taking a more privacy-centric approach than that shown in FIG. 9.

FIG. 10 illustrates an exemplary buyer client profile record created by the method of FIGS. 5-7 and 9.

FIG. 11 illustrates an exemplary seller client profile record created by the method of FIGS. 5 and 7-9.

FIG. 12 illustrates a buyer agent user interface.

FIG. 13 illustrates a seller agent user interface.

FIG. 14 illustrates a buyer client user interface.

FIG. 15 illustrates a seller client user interface.

FIG. 16 illustrates an agent rating and performance metrics user interface.

FIG. 17 illustrates an additional client services provider user interface.

FIG. 18 illustrates an additional client services provider cumulative ratings user interface.

FIG. 19 illustrates a schematic logical diagram of first embodiment of a method of building a message record that is stored in a message database.

FIG. 20 illustrates a continuation of the schematic logical diagram of the first embodiment of the method of building the message record of FIG. 19.

FIG. 21 illustrates a further continuation of the schematic logical diagram of the first embodiment of the method of building the message record of FIGS. 19-20.

FIG. 22 illustrates a further continuation of the schematic logical diagram of the first embodiment of the method of building the message record of FIGS. 19-21.

FIG. 23 illustrates an exemplary message record created by the method of FIGS. 19- 22.

FIG. 24 illustrates a schematic logical diagram of a method of distributing a stored message record from the message database to one of the three display output a reason the buyer and seller agent user interfaces and buyer client and seller user interfaces.

FIG. 25 illustrates a schematic workflow diagram of a method of client interaction with the system server via the buyer client user interface (of FIG. 14) or the seller client user interface (of FIG. 15).

FIG. 26 illustrates an exemplary buyer client user interface at a first step of the client transactions maintained by the system corresponding to the first step of the user interface in FIG. 25.

FIG. 27 illustrates an exemplary buyer client user interface at a second step of the client transactions maintained by the system corresponding to the second step of the user interface in FIG. 25.

FIG. 28 illustrates an exemplary buyer client user interface at a third step of the client transactions maintained by the system corresponding to the third step of the user interface in FIG. 25.

FIG. 29 illustrates an exemplary buyer agent user interface at a fourth step of the client transactions maintained by the system corresponding to the fourth step of the user interface in FIG. 25.

FIG. 30 illustrates a schematic workflow diagram of the method of client interaction at the fourth step with three stages with the system server via the client user interface.

FIG. 31 illustrates an exemplary buyer client at a third stage of the fourth step of the client transactions maintained by the system corresponding to the fourth step of the user interface in FIG. 29.

FIG. 32 illustrates a schematic workflow diagram of the method of agent interaction at the fifth step with the system server via the agent user interface and the client user interface.

FIG. 33 illustrates an exemplary agent user interface of a method of a buyer agent updating a mortgage status of the buyer client according to FIG. 32.

FIG. 34 illustrates an exemplary buyer client user interface updated in accordance with the action of the buyer agent updating the mortgage status of the buyer client according to FIG. 32.

FIG. 35 illustrates a schematic workflow diagram of a method of client and agent interaction at the fifth step including eight stages and a client status stage with the system server via the buyer client or seller client user interface.

FIG. 36 illustrates continuation of the schematic workflow diagram of FIG. 35 of the method of client and agent interaction at the fifth step including eight stages and a client status stage with the system server via the buyer client or seller client user interface.

FIG. 37 illustrates an exemplary buyer agent user interface of a method of the buyer agent selecting a buyer client stage.

FIG. 38 illustrates an exemplary buyer client user interface of the method of FIG. 37 indicating the selection of the buyer agent on the buyer agent user interface.

FIG. 39 illustrates an exemplary seller agent user interface of a method of the seller agent selecting a seller client stage.

FIG. 40 illustrates an exemplary seller client user interface of the method of FIG. 39 indicating the selection of the seller agent on the seller agent user interface.

FIG. 41 illustrates continuation of the schematic workflow diagram of FIGS. 34-35 of the method of client and agent interaction at the fifth step including a client status indicator with the system server via the buyer client or seller client user interface.

FIG. 42 illustrates an exemplary buyer agent user interface of a method of the buyer agent selecting a buyer client status.

FIG. 43 illustrates an exemplary buyer client user interface of the method of FIG. 41 indicating the selection of the buyer agent of the buyer client status on the buyer agent user interface.

FIG. 44 illustrates an exemplary client report.

FIG. 45 illustrates an exemplary agent user interface where the agent has selected a system feedback interface element to report an issue to the system administrator.

FIG. 46 illustrates an agent reporting user interface that is presented to an agent who selects the system feedback interface element of FIG. 45.

FIG. 47 illustrates the agent reporting user interface of FIG. 46 wherein the agent user has selected an ID issue corresponding to a data field and value they would like to report.

FIG. 48 illustrates the agent reporting user interface of FIGS. 46-47 wherein the agent user has selected severity value corresponding to a data field and value they would like to report.

FIG. 49 illustrates the agent reporting user interface of FIGS. 46-48 wherein the agent user has input freeform details corresponding to a data field and value they would like to report and subsequently selects a submission interface element to submit the report information to the system administrator.

FIG. 50 illustrates a system administrator report user interface that presents an accumulation of agent feedback for all data fields in the agent and corresponding buyer client and seller user interfaces.

FIG. 51 illustrates an exemplary computer system configured to support any of the system computational servers of FIG. 1 to enable the methods of the embodiments disclosed herein.

FIG. 52 is a flow diagram of an embodiment of this invention that captures declared user input, structures engagement data, and transmits the data to AI systems, potentially (and preferably) even before identity submission of a user.

### DETAILED DESCRIPTION OF THE INVENTION

Reference throughout this specification to “one embodiment,” “an embodiment, or similar language means that a particular feature, structure, or characteristic described in connection with the embodiment is included in at least one embodiment of the present invention. Appearances of the phrases “in one embodiment,” “in an embodiment and similar language throughout this specification may, but do not necessarily, all refer to the same embodiment.

The described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

While applications to real estate transactions are specifically disclosed herein, these are for illustrative purposes that provide teaching that can be used to apply this invention to other applications.

### Key Technical Problems This Invention Addresses (Continued From Above)

The invention provides systems and methods for addressing key technical problems that plague the relevant business and other sectors with new and advantageous solutions. Certain of these technical problems and the solutions provided by this invention, some or all of which can be included in certain embodiments, include those addressed above in the Summary, as well as:
1. Information Overload: With the digital era's information explosion, clients (e.g., real estate buyers) find themselves drowning in a sea of data, leading to decision paralysis. Embodiments of this invention do not merely present information. They provide advanced filtering algorithms that curate content that aligns with a client's unique criteria, factoring in the current market condition—whether it's a buyer's, seller's, or balanced market, and also considering the market trend—be it trending towards buyers, sellers, or balanced. This is achieved through a deep-dive user profile assessment combined with real-time market analysis.
2. Lack of Personalization: Every client's journey is distinct, and generic, one-size-fits-all recommendations can significantly deter their progress. Embodiments of this invention provide an adaptive learning system that is not static. It evolves with the client, adapting to interactions, feedback, and changing preferences, ensuring recommendations remain relevant.
3. Agent Alignment: With growing agent networks, maintaining a standardized service quality and adherence to company protocols becomes a herculean task. Embodiments of this invention provide integrated agent portals in that act as a real-time touchpoint. Beyond just updates, it's an interactive platform fostering agent growth, feedback, and alignment with the company vision.
4. Driving Agent Performance and Services Attachment: Traditional systems focus on after-the-fact performance reporting and, furthermore, clients aren't always aware of the full spectrum of available services. Embodiments of this invention provide a proactive system and methods that not only track but actively drive performance metrics. Its intuitive design ensures that clients are informed about a range of services like mortgages, legal aid, and others at the right moments.
5. Integration of Diverse Services: The fragmented nature of relevant (e.g., real estate) services often compels clients to jump between platforms. Embodiments of this invention offer a comprehensive suite of integrated services, from relevant access (e.g., property) viewing to final transaction closure. Partnerships enable access to additional services like mortgages, legal aid, and moving assistance, ensuring a seamless transaction process.
6. Feedback Mechanisms: Delayed feedback collection can lead to outdated data. Embodiments of this invention provide real-time feedback tools that capture client experiences at pivotal points in their journey, allowing businesses to dynamically adjust their offerings for maximum client satisfaction.
7. Client Trust Issues: The shift towards digital platforms, while efficient, often distances clients due to a perceived lack of transparency and personal touch. Embodiments of this invention provide transparency features demystify the relevant transfer process, providing clients with a clear, step-by-step view of their transactional journey, fostering a sense of security and trust.
8. Data-Driven Decision Making: The sheer volume of collected data can be overwhelming, often leading to paralysis by analysis. Embodiments of this invention simplify complexity. Their analytics tools process this data, transforming it into digestible, actionable insights that businesses can leverage for strategic decisions.
9. Reliable Independent Source of Information: In an era of information skepticism, clients often seek a secondary, neutral source of advice. Embodiments of this invention fill this void, drawing from the collective wisdom of top-performing agents, and offering unbiased advice. This not only provides validation for clients but enriches their decision-making process.
10. Empowering Agents with Timely Information and Training: When new services or significant changes in the relevant field emerge that could impact a client's specific situation, both the client and the supporting agent need to be informed. Moreover, agents require more in-depth knowledge and training to advise clients effectively. Embodiments of this invention address the symbiotic relationship between clients and their supporting agents. When there is a new service or a notable change in the relevant landscape that affects a client, these embodiments ensure that both the client and their supporting agent are advised of it. While the client receives pertinent information to keep them updated, the agent gets both this information and additional training materials via their dashboard. This dual-channel approach guarantees that agents are not only informed but are also equipped with the tools and training they need to provide expert advice. The aim of these embodiments is to guarantee that agents possess both the knowledge and the know-how to offer clients exceptional service, maintaining trust and promoting effective communication.
11. As described above in the Summary, which is incorporated by reference here (but not repeated), and in addition, certain embodiments of this invention provide several technical advancements, including providing: (a) concrete solutions to real technical problems, (b) practical applications with specific system logic that solves existing technical challenges, (c) improved functioning of technology to engage, personalize and learn from anonymous users, and (d) inventive and usable implementing concepts. These include the teaching of the application of an interface with AI systems/methods in one more steps or with one or more features in applications. This approach provides a technological improvement to digital engagement and AI systems/methods by creating a concrete, compliant, auditable, and intelligent method for structuring early-stage user data. The systems/methods enhance both platform functionality and AI model fidelity without relying on invasive or abstract processes.

While technology continues to revolutionize industries, the essence of real estate and other transactions remains in human connection. Embodiments of this invention recognize and commit to this philosophy by providing meticulously designed tools that not only address the modern challenges of the relevant sector but also underscore the importance of informed and well-trained agents, working in tandem with their clients.

### Open Access Engagement Tools and Privacy Centric Embodiments

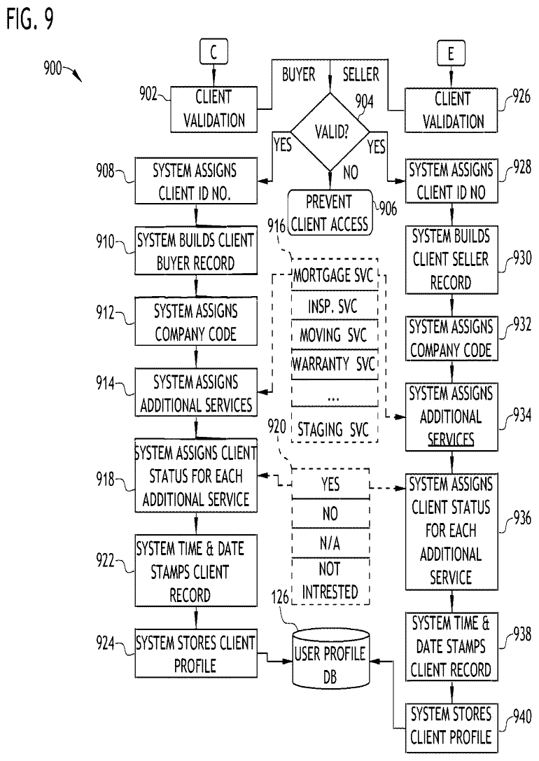

In certain of the most preferred embodiments of this invention, open-access engagement tools are used when capturing leads. In these embodiments, the previous uses of immediate contact data (e.g., some of which are described in alternative embodiments such as shown in part in FIG. 9) and/or behavioral tracking are either not performed, or they are used in conjunction with and/or subordinate to these open-access engagement tools.

These open-access engagement tools: (1) eliminate the need for upfront contact data, allowing personalized engagement without personal information; (2) gather user input preferences (e.g., budget, location, property type, etc.) and deliver personalized content based on this input rather than inferred data; (3) are rules-based and non-intrusive, maintaining user privacy while providing continuous personalized resources; and (4) expand visitor engagement, capturing early-stage and high visitors alike, providing a comprehensive engagement solution in the relevant technology market.

In conventional lead capture systems, user access to personalized resources and insights is typically gated behind contact data requests. Platforms like BoomTown, KVCORE, and Ylopo, for instance, capture leads by requiring personal information upfront or by using inferred behavioral analytics to determine user intent. Embodiments of this invention that use open-access engagement tools, however, flip this paradigm. By enabling users to explore personalized resources without the need to provide contact information, these embodiments open a unique gateway to visitor engagement.

This shift from gated to open-access engagement is a defining feature of these embodiments that presents an entirely new category of lead capture, which represents a significant departure from the conventional high-pressure data-collection systems used in previous technology. This approach creates a user-friendly, non-intrusive experience, encouraging users to remain engaged without requiring immediate commitment.

The open-access engagement tools of this invention provide platforms, systems and methods that operate differently from the past in how they capture, retain, and nurture leads. Traditional lead capture tools primarily focus on obtaining contact data quickly to enable follow-ups, whereas open-access engagement tools of this invention leverage user-stated preferences to deliver relevant content without requiring upfront personal data.

For example, in certain of these embodiments, important user (e.g., buyer) information (such as budget, location, and property preferences) is gathered directly from the user without requiring contact details. By not relying on behavior tracking or AI inference but rather on stated preferences, these embodiments are further differentiated from existing technologies. In certain of these embodiments of this invention, continuous access to personalized resources is provided, creating a customized, evolving experience within the agent's existing website.

Advantages of the embodiments using the open-access engagement tools of this invention will be readily apparent to a person of skill in the art. These embodiments are intentionally user-centric, providing an environment where visitors can engage freely without feeling pressured to share their information prematurely. A HubSpot study shows that 65% of users abandon websites when asked for personal data too early, underscoring how intrusive data requirements can deter engagement. By capturing this unique user-focused aspect of these embodiments, these embodiments not only offer a technical advancement but also improves use experience significantly over traditional systems. This non-intrusive, welcoming approach lowers barriers to engagement and fosters trust. This leads to higher visitor retention and extended engagement, making these embodiments using open-access engagement tools of this invention not only distinctive but also highly effective.

These open-access engagement tools allow these embodiments to capture and nurture a wider range of website visitors, from early-stage browsers to high-intent users, without requiring contact information. Traditional lead generation systems are confined to high-intent users who are willing to share their details immediately. These embodiments, on the other hand, broaden this scope, capturing early-stage leads that other systems might overlook. By offering access to personalized resources from the start, these embodiments can build meaningful relationships with these visitors over time, creating a pipeline of qualified prospects.

These embodiments are a market innovation, and, in particular, a shift from targeting immediate leads to building a comprehensive audience engagement strategy. The ability of these embodiments to engage users across the entire spectrum of the buying journey, ensuring long-term brand loyalty and engagement without invasive tactics. This distinction positions these embodiments as a market leader in inclusive lead capture.

Advantages of these open-access engagement tools include the following, as well as additional advantages that will be apparent to a person of skill in the art practicing these embodiments:
1. Privacy-Centric Approach: In an environment where data privacy is a major concern, certain embodiments of this invention provide personalized messages without requiring personal data, which is highly innovative and a break from the past. This directly addresses privacy concerns and regulatory requirements such as GDPR and CCPA in a novel manner.
2. Technical Challenge: Achieving personalization without relying on personal data is a complex technical challenge. Certain embodiments of this invention use proxy indicators, including company code, step, price tier, state, and client type, to infer relevance—allowing personalization while avoiding personal information collection. This approach is an effective workaround to a problem faced by most personalization technologies today.
3. Differentiation from Existing Systems: Most systems require personal data to function effectively. By successfully providing personalization without such data, the approach of certain embodiments of this invention sets them apart, making them a unique innovation in the field.
4. User Engagement and Conversion: Many users abandon websites when asked to provide personal information during signup. By eliminating the need for personal data to access and interact with the system, certain embodiments of this invention encourage more users to engage, resulting in greater interaction and ultimately more clients for agents. Users only need to share their personal information once they decide to move forward with an agent, which significantly reduces friction early in the process.
5. Broad Applicability: While this invention was first designed for real estate, this privacy-preserving personalization concept has broad applications across industries, which can demonstrate its wider utility.
6. Addressing a Market Need: There is growing demand for solutions that respect user privacy while delivering personalized experiences. Certain embodiments of this invention directly address this need, which adds value to the platforms, systems, and methods.
7. Overcoming Traditional Limitations: Typically, personalization quality is believed to be linked to the amount of personal data available. These open-access engagement tools challenge that assumption, opening up new opportunities in personalization technology.
8. Compliance and Ethics: By not requiring personal data, the open-access engagement tools of this invention inherently support compliance with data protection regulations and align with ethical data use practices, which is an increasingly important aspect of technology development.

These aspects collectively transform these embodiments from a conventional messaging system into an innovative solution that tackles both technological and societal challenges. The privacy-centric design, along with the complex rules-based distribution logic, supports the system's novelty and usefulness over previous systems.

### Anonymized Data Tracking Using a Code

This invention provides innovative tools designed to transform user interaction in the relevant industry by providing automated, personalized advice to potential homebuyers without direct agent involvement. One key feature of preferred embodiments is an anonymized data tracking system, which assigns each user a unique 12-digit code (other similar multi-digit or highly informational codes can also be used) to maintain privacy while enabling agents to monitor engagement and understand user behavior.

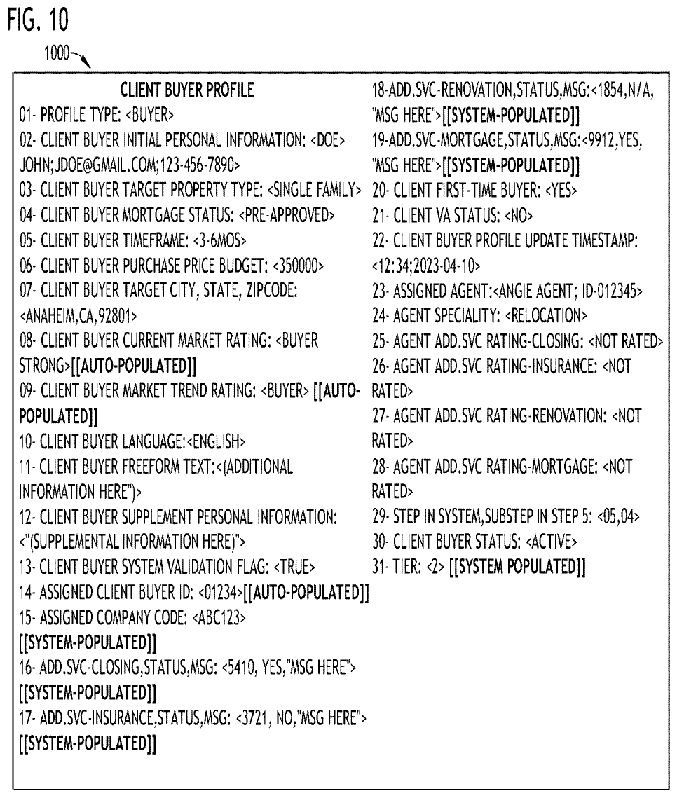

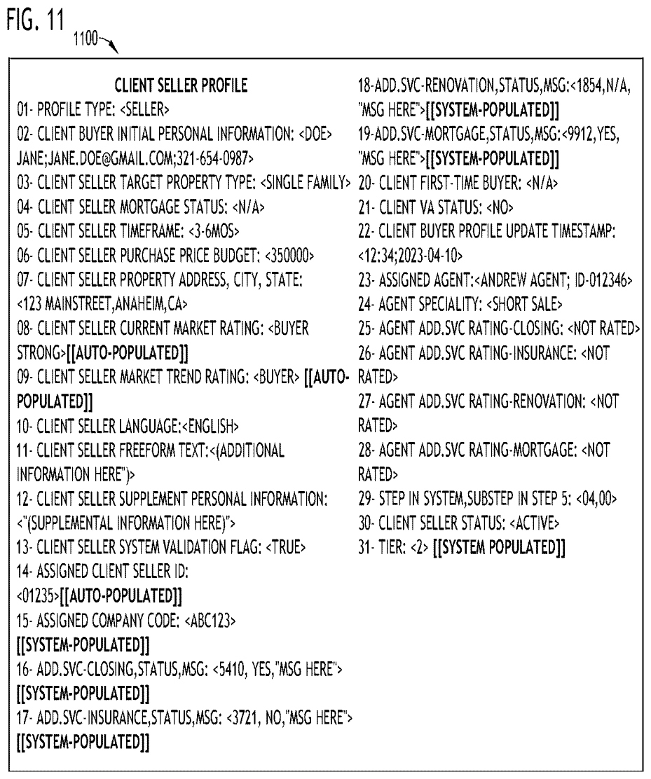

For example, an anonymized tracking system of preferred embodiments of this invention can use a unique 12-digit code assigned to each user who interacts with the platform. This assigned 12-digit code is referenced in FIGS. 10 and 11 as #14, the assigned buyer/seller ID. The first four characters of this code represent the month, day, and year of interaction. The first character is a letter indicating the month, starting with “A” for January, “B” for February, and so on. The next two characters are numeric, representing the day of the month (e.g., “01” for the 1st day). The fourth character is also a letter representing the year, starting with “A” for 2024, “B” for 2025, and so forth. For example, a code starting with “B08A” indicates that the user interaction took place on Feb. 8, 2024. The remaining eight characters are randomly assigned, ensuring that each code is unique for that day.

This system allows agents to see when users engaged with the platform while maintaining anonymity. Agents do not have access to personal information such as names or contact details but can still track interaction patterns, understand which content was accessed, and assess the system's effectiveness in guiding potential clients.

The embodiments of this invention that use an anonymized tracking system offer several benefits to participating agents. First, it allows agents to gauge user engagement without requiring upfront identification. Agents can see how many users interacted with their website on any given day and which features of the website were most frequently accessed. This data helps agents refine their marketing efforts, improve automated services, and better understand what users are looking for at different stages of the home-buying process.

Additionally, the system provides agents with insights into user behavior over time. By understanding when users interact with the system and what information they seek, agents can determine which topics are of greatest interest. For example, if many users access information about mortgage options in June, agents could focus their marketing on financial assistance during that time. These insights help agents improve their business strategies without compromising user privacy.

The code (e.g., 12-digit code) system of these embodiments addresses concerns about data privacy and user consent. Unlike traditional customer relationship management (CRM) systems that require personal details, these embodiments enable users to engage anonymously, providing personalized advice without revealing their identity. This approach respects users' desire for privacy while still offering valuable insights to agents.

Tracking user interaction by date and behavior rather than personal information ensures that these embodiments comply with modern data privacy standards. By separating user data from personal identification, the system reduces the risks associated with data breaches or misuse. This feature aligns with broader trends in the technology industry, as companies shift toward privacy-centric models in response to regulations like the General Data Protection Regulation (GDPR).

This anonymized multi-digit (e.g., 12-digit) code system represents a significant advancement in user interaction tracking, offering agents valuable insights while ensuring user privacy. By assigning a unique code that incorporates the interaction date and anonymized data, these systems enable agents to monitor engagement, refine their strategies, and enhance the home-buying experience without compromising personal information. This privacy-focused approach is both innovative and crucial in an era where data protection and user consent are top priorities. Anonymized tracking offers a blueprint for future technologies seeking to balance personalization and privacy effectively.

In some preferred embodiments, the anonymized multi-digit code may optionally be linked to a user-defined password to allow the user to resume their session across devices or time periods without the use of cookies or persistent tracking. The system and method may prompt the user to enter a password and record the date of engagement (e.g., displayed to the user or embedded in the anonymized code). To resume the session later, the user re-enters the password along with the date or a portion of the anonymized code corresponding to the original session date. This combination may be hashed and matched server-side to securely retrieve the prior engagement profile. Importantly, the password and session linkage process does not require any personally identifiable information (PII), and users are explicitly instructed not to use names, emails, or contact information in creating the password. This approach enhances user continuity and cross-session personalization while maintaining strict compliance with privacy standards such as GDPR and CCPA.

### Overview of Certain Aspects of This Invention

The systems and methods of this invention are designed to optimize user (e.g., real estate buyer) interactions with human and/or AI agents. Certain embodiments use a set of core components (e.g., provided in segments and/or modules) that comprise:
1. User Database: The User Database stores user-specific information using Relational or NoSQL databases. It offers the benefit of having centralized user management improving data integrity and security.
2. Message Database: The Message Database contains messages that users send and receive using message queuing systems like RabbitMQ or Apache Kafka. It offers the benefit of providing efficient and timely message distribution, enhancing communication flow.
3. Client Profile Database: The Client Profile Database holds details about users' preferences and behaviors and adapts as clients progress through buying/selling stages. It offers the benefit of providing personalized, dynamic user interactions based on real-time data.
4. Client Report Database: The Client Report Database stores PDF files for full client record access. It offers the benefit of facilitating detailed reporting and data retention.
5. Application Server: The Application Server acts as the interface between all databases. It offers the benefit of streamlined request processing and real-time data retrieval for timely message dissemination.
6. API: API facilitates interaction with all databases. It offers the benefit of providing integration capabilities with other services and applications for enhanced functionalities.
7. Authentication & Authorization: Authentication & Authorization provides mechanisms using standards like OAuth2 or JWT. It offers the benefit of ensuring data security and user-specific access controls.
8. Scalability & Availability: Scalability & Availability provides deployment on cloud platforms. It offers the benefit of ensuring the systems' uninterrupted accessibility and adaptability to traffic surges.
8. Data Synchronization: Data Synchronization maintains consistency among all databases. It offers the benefit of accurate, up-to-date data across the system, enhancing reliability and performance.

In essence, the invention's modular design ensures efficient (e.g., real estate) interactions, capitalizing on real-time data to offer personalized, secure, and scalable solutions.

### Client Profile

In the present-day digital domain of real estate, for example, the importance of delivering a custom-tailored experience to all clients—be they buyers or sellers—is important. Conventional systems often dispense broad, one-size-fits-all information that doesn't align with individualized needs or phases in the process. The present need is for a system that is not static, but dynamically evolves with the client, disseminating precise, real-time data based on the client's specific stage and unique circumstances.

The Client Profile within this invention is devised with a state-of-the-art digital structure, aimed at adapting, recording, and responding to the diverse details and continuously changing phases of a client's journey, whether they're looking to buy or sell. The capabilities of the Client Profile (e.g., provided in segments and/or modules) include the following:

Dynamic Nature: Diverging from traditional static frameworks, the Client Profile is defined by its fluid nature. As clients navigate through their journey in a particular field or industry—whether it's transitioning from property browsing to engaging with mortgage providers or preparing a property for listing—the profile acknowledges this progression in real-time.

Automated Messaging System: At the core of the Client Profile's potency is its innovative automated messaging mechanism. As the Client Profile undergoes changes, be it from milestones like aligning with a mortgage provider or deciding on a property listing price, the system springs into action, automatically generating messages perfectly aligned with the client's immediate needs and circumstances.

Benefits: The multiple benefits provided by the Client Profile aspects of this invention include the following;
1. Scalable Personalization: The concept of personalization in real estate, as well as other applications, achieves groundbreaking scalability with the Client Profile. This ensures that each client's distinct journey, whether buying or selling, is acknowledged and addressed, leading to enhanced system efficiency.
2. Facilitating Prompt Decisions: Timely and accurate messages empower clients to make knowledgeable decisions promptly, removing the usual hurdles and indecisions of the transaction journey.
3. Elevated Client Satisfaction: The custom experience made possible by the dynamic profile coupled with the intelligent messaging system heightens client trust, satisfaction, and dedication to the process.
4. Agent and Service Provider Efficiency: With the Client Profile rendering a comprehensive insight into the client's journey, agents and service providers can perfectly align their strategies with the system's advice and recommendations, ensuring the clients path is constantly optimized.
5. Uniqueness: The standout feature of the Client Profile is its unparalleled ability to meld real-time profile adaptation with a sophisticated messaging system. This invention cohesively integrates them, ensuring the client's journey, be it buying or selling, is always in alignment with real-time needs and changes.

The Client Profile within the systems and methods of this invention represents a significant advancement in transaction-related (e.g., real estate) and engagement platform technology. It addresses the industry's pressing requirement for real-time personalization and contextually relevant messaging, optimizing the overall experience for both buyers and sellers. Through its dynamically adaptive nature and synchronized messaging capabilities, the system sets a new standard for digital client experiences in real estate and other industries.

### Buyer Agent User Interface (UI)

The Agent Dashboard is an important aspect of certain embodiments of the systems and methods of this invention, and marks a transformative shift in real estate and other interactions. Seamlessly integrating advanced technology with the nuanced dynamics of the agent-client relationship, this dashboard is not merely an adjunct tool but a holistic solution. Designed specifically to fortify the synergy between buyers and their agents, it emphasizes cohesiveness, transparency, and enhanced collaboration. The capabilities (e.g., provided in segments and/or modules) include the following:

Upon entry, agents encounter a dashboard, both sophisticated and user-centric. It unfolds into eight meticulously curated sections, each mirroring the multifaceted nature of real estate and other transactions and emphasizing cooperative buyer-agent engagements.

The ‘What Happens Next’ segment acts as a beacon, illuminating the relevant (e.g., property) acquisition pathway for agents. It presents a transparent roadmap, providing agents with anticipatory insights about ensuing stages, positioning them to navigate buyers with informed clarity.

Within the ‘Recommendation’ module, agents find a dynamic reservoir of insights. It actively mirrors the guidance, tips, and recommendations that the system shares with the buyer via their dashboard. Far from being siloed suggestions, these are reflections of comprehensive market analysis, ensuring agents have a synchronized understanding, parallel to what the buyer perceives.

The ‘Reports’ section blossoms as a rich repository of actionable intelligence, encompassing ‘Expert Tips’, ‘Additional Services’, and ‘Insights’. These are tailored to match the buyer's journey, transforming agents into well-prepared consultants always on the same page as their clients.

The ‘Tell Us’ feature emphasizes the invention's commitment to continuous evolution. This real-time feedback channel, linking agents to system developers, is a testament to the platform's dedication to being shaped by its most vital users.

The transformative ‘Agent Message’ area provides agents with supplementary details that accompany the tips or recommendations shared with the buyer. This synchronization ensures agents are not only reactive but proactively equipped to address buyer queries or concerns, reinforcing their image as trusted and informed partners.

The ‘Buyer Property Data’ module (or “buyer interest data” module, depending on the application) combines buyer preferences with up-to-the-minute market insights. Such a fusion enables agents to make predictions, guide clients based on market trends, and stay attuned to buyers' evolving preferences.

With the ‘Buyer Contact’ segment, agents are afforded the luxury of streamlined communication. An intuitive switch mechanism facilitates swift access to buyer-specific communications, embodying both efficiency and timeliness.

The dashboard's hallmark is its adaptability. Recognizing the fluid nature of real estate and other interactions, it offers agents the facility to swiftly update buyer statuses, ensuring a real-time and harmonized flow of information.

The Agent Dashboard redefines the paradigm of real estate and other technology. By presenting agents with an aligned view of the information that the buyer receives, it facilitates a collaborative and harmonized working dynamic. This synchronized approach, blending the expertise of agents with cutting-edge technology, promotes a transparent, informed, and cohesive buying experience. Through this harmonization, the Agent Dashboard underscores a future where technology and human expertise work in unison, fostering a collaborative and efficient real estate and other relevant ecosystem.

### Seller Agent User Interface (UI)

In the intricate tapestry of the seller (e.g., real estate) sector, the Seller Agent Dashboard emerges as a groundbreaking component of embodiments of the systems and methods of this invention. Seamlessly weaving advanced technology with the nuanced demands of the agent-seller partnership, this dashboard offers more than just support—it offers synergy. It's meticulously designed to augment the collaboration between sellers and their agents, ensuring fluidity, transparency, and an enriched selling experience. The capabilities (e.g., provided in segments and/or modules) include the following:

Upon accessing the dashboard, seller agents are greeted with an interface that is both sophisticated and seller-centric. Comprising eight distinct sections, each element is fine-tuned to mirror the complexities and requirements of the real estate and other transactional selling process, ensuring a harmonized agent-seller interaction.

The ‘What Happens Next’ segment acts as a guiding light for agents, elucidating the path ahead in the selling process. It offers a clear roadmap, arming agents with insights regarding the subsequent stages of a seller's journey, empowering them to guide sellers with informed clarity and foresight.

The ‘Recommendation’ module stands out as a pivotal ally for seller agents. It actively reflects the guidance, tips, and strategies that the system shares with the seller via their dashboard. These insights, a culmination of comprehensive market research and analysis, ensure that agents maintain a cohesive perspective in alignment with what the seller receives.

The ‘Reports’ arena unravels as a treasure trove of actionable insights, including ‘Expert Tips’, ‘Additional Services’, and ‘Insights’. Aligned with the seller's journey, these facets ensure that agents can anticipate and respond to seller queries or concerns, bolstering their role as trusted advisors.

The ‘Tell Us’ feature underscores the invention's dedication to evolution. This real-time feedback mechanism, bridging agents and system developers, encapsulates the platform's commitment to evolving based on ground-level insights and feedback.

The ‘Seller Message’ section is especially transformative. Here, agents receive comprehensive information accompanying the tips or strategies presented to the seller. This congruence guarantees that agents are proactively primed to address any seller queries, enhancing their role as informed and synchronized partners.

The ‘Seller Property Data’ (or ‘Seller Interest Data’, depending on the application) segment fuses seller preferences with real-time market data. This blend grants agents the foresight to guide sellers based on prevailing market dynamics, ensuring that pricing and listing strategies are optimized.

Navigating the ‘Seller Contact’ module, agents benefit from streamlined communication. An intuitive interface ensures quick access to seller-specific interactions, epitomizing both responsiveness and precision.

One of the crowning features of this dashboard is its adaptability. In a sector as fluid as for real estate, for example, it allows agents to swiftly modify seller statuses, guaranteeing a real-time and synchronized information flow.

The Seller Agent Dashboard is poised to redefine the technological landscape of real estate and other industries for sellers. By offering agents a parallel view of the insights and information presented to the seller, it establishes a foundation for cohesive, informed, and efficient seller-agent collaboration. Through this synchronized approach, the Seller Agent Dashboard paves the way for a future where technology and human expertise merge seamlessly, enhancing the overall selling experience and sculpting a new era for the real estate and other relevant industries.

### Buyer Client User Interface (UI)

In the ever-evolving landscape of real estate and other applications, navigating the intricate steps of buying a property, as an example, can often be a daunting endeavor. Recognizing this challenge, embodiments of the systems and methods of this invention introduces an innovative solution—the Buyer Dashboard. This interface is tailor-made for prospective buyers, ensuring they have a guided, informed, and streamlined acquisition journey. The capabilities (e.g., provided in segments and/or modules) include the following:

‘What Happens Next’: Specifically oriented towards buyers, this interactive roadmap adjusts based on the buyer's progression, elucidating the subsequent steps of their purchasing journey. It's more than just a checklist—it provides insights and expectations for the next stages, ensuring buyers remain proactive and confident.

‘Recommendation’: Leveraging advanced algorithms, this section deduces the buyer's position in the acquisition cycle, offering precise suggestions to guide them seamlessly through every decision point.

‘Reports’: This segment provides buyer-centric analytics. The ‘Expert Tips’ feature provides insights from seasoned professionals, tailored to the buyer's unique circumstances and market position, facilitating informed decisions.

‘Additional Services’: Catering to buyers' needs, this section introduces relevant services, such as mortgage consultants, legal aids, or property valuation experts, integrating them at the right moment to ensure every buyer's requirement is addressed.

‘Insights’: Acting as a continuous knowledge stream, it offers articles and updates that are pertinent to buyers, helping them understand market dynamics, pricing strategies, and other relevant facets.

‘Home Search & Recommendations’: This tool, leveraging AI capabilities, refines property suggestions to align with the buyer's preferences and budget, making the search process more intuitive and productive.

‘Buyer Data & Market Analysis’: Tailored for buyers, this section fuses overarching market trends with buyer-specific data, offering insights on pricing, locality advantages, and more, all personalized to the buyer's perspective.

Progress Visualization Segment: A unique feature of embodiments of the systems and methods of this invention include this section, which provides real-time visualization of a buyer's journey. Agents have the capability to manually update specific progress markers, ensuring both the buyer and agent stay aligned. This shared view fosters collaborative decision-making.

Given the dynamic nature of buying, financial aspects play a pivotal role. Depending on the buyer's mortgage status and financial position, the dashboard offers actionable advice and recommendations. By continuously updating its contents in real-time as the buyer advances, it ensures that both the buyer and the agent have synchronized access to the same insights, fostering harmonious collaboration.

In summation, the Buyer Dashboard of these embodiments is a game-changer in the real estate and other relevant tech domain. Tailored specifically for buyers, it amalgamates technological prowess, expert insights, and a user-centric design to revolutionize the buying experience. By offering real-time updates, personalized recommendations, and collaborative features, it empowers buyers and their agents to work in tandem, ensuring informed decisions throughout the acquisition journey.

### Seller Client User Interface (UI)

In the intricate realm of real estate and other applications, selling a property, for example, introduces its own unique set of challenges and complexities. Responding to the pressing needs of sellers, embodiments of the systems and methods of this invention provide a Seller Dashboard. This innovative interface is meticulously crafted for individuals and entities looking to sell properties, ensuring they are equipped, informed, and poised for a successful transaction. The capabilities (e.g., provided in segments and/or modules) include the following:

‘What Happens Next’: Designed with sellers in mind, this dynamic roadmap evolves based on the seller's journey. It doesn't just list tasks but offers clarity on upcoming milestones in the selling process. This proactive approach helps sellers understand and anticipate the subsequent phases, giving them control and confidence in their decisions.

‘Recommendation’: Through sophisticated algorithms, this section interprets the seller's progression in the real estate or other business cycle, dispensing precise advice tailored to guide them through each pivotal moment of their transaction.

‘Reports’: Here, sellers access crucial analytics geared towards their needs. The ‘Expert Tips’ feature imparts wisdom from real estate and other relevant business veterans, customized to the seller's specific circumstances, empowering them to make strategic decisions rooted in experience and data.

‘Additional Services’: Recognizing the integral role of closing services in a successful transaction, this segment timely introduces sellers to essential services such as closing agents, property appraisers, and legal consultants. By integrating these services at crucial junctures, the Seller Dashboard ensures the sale's legal and financial integrity.

‘Insights’: This continuously updated reservoir equips sellers with articles, market analyses, and selling strategies. From staging tips to understanding buyer psychographics, it provides sellers with a competitive edge in a demanding market.

‘Property Showcase & Recommendations’ (or other applicable title for showcase and recommendations): This tool optimizes the presentation of the seller's property (or what is for sale) and recommends marketing strategies, ensuring the (or what is for sale) resonates with the right audience and fetches optimum value.

‘Seller Data & Market Analysis’: Tailored for the seller's lens, this section juxtaposes macro market trends with specific data, offering insights on competitive pricing, neighborhood comparisons, and potential buyer demographics, all contextualized for the seller.

Progress Visualization Segment: This distinctive feature of embodiments of this invention provides real-time visualization of a seller's journey. Real estate and other agents can manually update specific progress indicators, creating a transparent, shared perspective between the seller and agent, promoting aligned decision-making.

Acknowledging the intricacies of selling, the dashboard's focus on Seller Closing services is pivotal. Depending on the seller's position in the sales cycle, the dashboard curates actionable advice, ensuring that every legal, financial, and procedural aspect of the transaction is comprehensively addressed. With its real-time updates, it cultivates a synchronized, transparent communication channel between the seller and their agent.

The Seller Dashboard of embodiments of this invention is a transformative leap in the realm of and other relevant technology. Specifically sculpted for sellers, it amalgamates state-of-the-art technology, seasoned expertise, and user-centric design to redefine the selling paradigm. By furnishing real-time data, tailor-made advice, and collaborative elements, it empowers sellers and their agents to seamlessly navigate the intricate tapestry of sales, ensuring every decision is informed, strategic, and aligned with the seller's objectives

### Agent Performance Metric Report Embodiments

Overview and Purpose: In the modern real estate landscape, as well as in other applications, a consistent challenge persists—i.e., equipping agents with real-time, comprehensive insights that optimize client interactions and elevate service utilization. Addressing this challenge, embodiments of this invention developed and use the Agent Performance Metrics Report. Unique in its approach, this report offers a real-time snapshot of an agent's interactions with clients and how well they are leveraging the additional services offered by the referral company. The capabilities (e.g., provided in segments and/or modules) include the following operational mechanisms and uniqueness:

Agent Details and Date Range: At the outset, the report captures fundamental data—the agent's unique ID and the date range for transactions. This forms the base layer, ensuring all subsequent analyses are contextually anchored.

Client Information: This section offers critical client-centric data, from client assignment date to their current status. It distinguishes clients based on their profile—buyer or seller. Additionally, the built-in pull-down menu enables agents to toggle between different clients, ensuring the flexibility of insight retrieval.

Additional Services and Ratings: Beyond transactional details, the report delves into the realm of service engagement. It not only captures the current level of client engagement with the offered services but also collects the agent's qualitative feedback. The feedback, categorized into Price, Quality, Service, and other discernible metrics, is designed to be intuitive and insightful. The ‘Current Client’ field's real-time update feature ensures fidelity in tracking service engagements, while the collected feedback aids ongoing service refinement.

Data Visualization: The data harvested isn't merely stored but is transformed into comprehensive graphic representations. Though not visible to agents, these visual outputs empower the referral company with an immediate understanding of service reception and areas of potential improvement. This visual data is malleable, with the capability to be viewed from multiple perspectives—by agent, geographical location, broker, and more. The transformative nature of this feature lies in its ability to convert raw data into actionable insights.

Agent Notes: This section allows agents to document qualitative observations, challenges, and more. These notes enhance intra-company communication, aiding problem resolution and ensuring that all stakeholders have a holistic understanding of the client's journey. An integrated ‘Update’ feature ensures data integrity and continuity.

Client Status by Category: Offering an expansive viewpoint, this section categorizes each client's transactional status. Agents gain a clear perspective of where each client resides in their real estate or other relevant journey, enabling proactive strategizing and more successful future transactions.

Attachment Rate for Services: This final section elucidates the agent's efficiency in promoting additional services. By juxtaposing potential versus actual service utilization, an attachment rate is generated. This metric, presented in real-time, offers agents a mirror to their service promotion efficacy, ensuring alignment with broader company objectives.

The Agent Performance Metrics Report, developed for embodiments of this invention, is a pioneering solution in the relevant (e.g., real estate) technological sphere. By amalgamating transactional data, service utilization, qualitative feedback, and visual insights, it ensures agents and referral companies remain in lockstep, promoting informed decision-making and continuous performance enhancement. The report embodies a transformative bridge between the agent's ground-level interactions and the referral company's strategic imperatives, sculpting a future where data-driven insights drive excellence in the relevant industry (e.g., real estate).

### Internal Support Dashboard

The Internal Support Dashboard is a sophisticated tool integrated within embodiments of this invention. This dashboard is meticulously designed to assist internal support teams in promptly identifying clients, understanding their journey, and efficiently offering support for a myriad of additional services offered by referral companies. By streamlining tasks and presenting real-time insights, the dashboard not only optimizes the support process but also elevates the overall client experience. The capabilities (e.g., provided in segments and/or modules) include the following:

Dashboard Design And Layout: Upon accessing the embodiment of this invention, support staff are greeted by the Internal Support Dashboard, organized into seven clearly delineated sections. Each section is explicitly crafted to cater to specific facets of client interaction, ensuring that support teams have a panoramic view of the client's journey.

Client Data Section: At the dashboard's outset, support staff are provided with the foundational data, including the client's contact details, type (buyer/seller), current status in their real estate or other relevant journey, and their associated agent's contact information.

Property Data Segment: This section delves into the nuances of a client's interests, whether as a buyer or a seller. By offering specifics such as type, location, and financial metrics, it enables the support team to tailor their assistance precisely.

Additional Services Interaction: More than just a tracking tool, this section offers real-time insights into a client's engagements with various additional services from the referral company. A drop-down menu lets support staff document the client's level of involvement, ensuring up-to-the-minute accuracy.

Automated Communications And Client's Journey: Recognizing that every client's journey may necessitate numerous system communications, a ‘System Communication Log’ is incorporated. This section meticulously logs every automated message dispatched, timestamped, and marked with the client's progress stage. Notably, support staff can view the entire content of messages, ensuring they're apprised of prior communications.

Collaborative Note-taking Features: The dashboard promotes seamless interdepartmental collaboration through two note-taking sections—‘Active Department Notes’ for real-time inputs and ‘Other Department Notes’ for visibility into insights from other teams. This feature ensures that all departments are continually updated, fostering a unified, consistent approach to client support.

Update Button: Central to data integrity, the dashboard includes an ‘Update’ button, locking in all session changes, ensuring that all modifications are appropriately captured.

Unique Selling Propositions (USPs): The Internal Support Dashboard distinguishes itself in several key ways:
1. Personalized Client View: The dashboard, by offering a detailed client view based on the logged-in support staff, ensures that each team member has a tailored experience, presenting only the most relevant information.
2. Collaborative Ecosystem: The dashboard fosters a synergistic approach to client support. With note-sharing features, departments can effortlessly communicate, ensuring a coherent and consistent client experience.
3. Real-time Service Engagement: The dashboard's dynamic design ensures that support teams can document and view real-time service engagement levels, offering a current snapshot of client interactions.
4. Centralized Communication History: By integrating a comprehensive log of system communications, the dashboard ensures that support teams are always informed of prior client messages, fostering continuity and consistency in client interactions.

The Internal Support Dashboard, within the embodiments of this invention, represents a novel approach to internal support in the realm of real estate and other relevant referrals. It's not merely a tool but an ecosystem, driving efficiency, collaboration, and informed decision-making. By offering a real-time view into client interactions, promoting interdepartmental collaboration, and ensuring continuity in communications, it redefines the paradigm of client support, aligning with the ethos of delivering unparalleled client experiences.

### Additional Services & Ratings

In today's dynamic real estate and other application landscape, understanding client engagements and optimizing service offerings is paramount. The ‘Additional Services & Ratings’ feature, embedded within the Agent Performance Metrics Report, stands as a testament to this modern imperative. The capabilities (e.g., provided in segments and/or modules) include the following:

Operational Depth and Breadth: At its core, this section acts as a rich repository, meticulously capturing a wide array of data points in real-time. As agents interface with various services, every interaction, every touchpoint, is documented. Whether a client shows interest in valuation, legal consultations, or moving services, the system captures this engagement.

But beyond mere data logging, this section delves deeper. Agents, given their front-line interactions with clients, are in a unique position to provide qualitative feedback on these services. To harness this invaluable insight, the system offers agents the capability to rate the services on multiple criteria, from service efficiency, quality, and responsiveness to the overall client satisfaction. These ratings are not mere numbers; they encapsulate the very essence of client sentiment, translating abstract feelings into tangible metrics.

Feedback as a Dual-Edged Sword: While the immediate utility of this feedback mechanism is to offer agents and the referral company a snapshot of current client sentiments, its implications run much deeper. This feedback, in its aggregate form, provides the referral company with an eagle-eye view of how its services are received on the ground.

But more than just a passive reception mechanism, this feedback drives action. By highlighting areas of excellence and pinpointing potential pain points, it offers the referral company a roadmap for service refinement. If a particular service consistently receives lower ratings, it signals an area ripe for intervention, whether in the form of enhanced training, process refinement, or resource allocation.

Moreover, in an industry where client preferences and needs are ever-evolving, this continuous feedback loop ensures that the referral company remains agile. By aligning its service offerings with real-world client expectations, it ensures that its value proposition remains robust, relevant, and resonant.

Holistic Integration: The beauty of the ‘Additional Services & Ratings’ feature lies in its integration. It's not a standalone segment but is interwoven with other sections of the Agent Performance Metrics Report. For instance, agents' qualitative observations documented in the ‘Agent Notes’ section can offer context to the ratings, providing a more nuanced understanding.

The ‘Additional Services & Ratings’ section embodies the fusion of technologies precision with the invaluable human touch. By capturing real-time service engagements and marrying them with qualitative agent ratings, it provides a holistic picture of client interactions. More than just a data collection tool, it serves as a strategic asset, fostering informed decision-making, continuous service refinement, and ensuring that the referral company's offerings remain in perfect harmony with client expectations and needs.

### Message Building Systems and Methods

In the vast landscape of real estate and other application technology, effective and personalized communication stands paramount. It is no longer sufficient to send generic messages; modern clients demand content tailored to their unique needs and preferences. With diverse client profiles and rapidly changing market dynamics, the challenge is to provide messages that are not only relevant but also timely, actionable, and engaging. The capabilities (e.g., provided in segments and/or modules) include the following:

An innovative Message Building System is provided in these embodiments that is meticulously designed to craft and distribute tailored messages for both clients and agents. This advanced system integrates a vast array of data points from user profiles, real-time activities, and market trends, curating personalized messages that resonate with the recipient's immediate context.

Benefits from these embodiments include:
1. Dynamic Personalization: The system automatically extracts pertinent data from user profiles and activities, ensuring that each message sent is tailored to the recipient's current needs, preferences, and status within the real estate and other relevant journey.
2. Timely Communications: As users progress through the buying or selling process, the system responds in real-time, delivering messages aligned with their current phase. This ensures clients and agents always receive information relevant to their immediate context.
3. Efficiency and Reduced Redundancy: By curating messages based on user profiles and activities, the Message Building System avoids bombarding users with irrelevant or redundant information. This leads to increased engagement as recipients recognize the value in every communication received.
4. Enhanced Engagement: The system's ability to craft personalized messages ensures that clients and agents are more likely to engage with the content, leading to improved user satisfaction and better outcomes.
5. Data-Driven Insights: Beyond mere personalization, the system employs advanced analytics to optimize message content, timing, and delivery based on user engagement metrics. This continuous learning approach refines the messaging strategy.
6. Seamless Integration with Other Systems: The Message Building System is designed to work in harmony with other components of embodiments of this invention, such as the real estate transition tracking, ensuring that messaging is always informed by the most up-to-date data.
7. Scalability: As the database of users grows and market dynamics evolve, the Message Building System is adept at scaling its operations, ensuring that the quality and relevance of messaging are consistently maintained.
8. Uniqueness: While many platforms might offer personalized messaging, the Message Building System of these embodiments stands distinct due to its deep integration with real-time user data, market insights, and dynamic adaptability. It is not a mere notification system but a comprehensive communication solution, meticulously crafted to understand, engage, and resonate with every individual user.

The Message Building System within these embodiments marks a pivotal advancement in the realm of real estate and other relevant communication strategies. By championing dynamic personalization, real-time responsiveness, and data-driven optimization, it redefines the standards for user engagement and satisfaction. This system underscores the invention's commitment to placing the user at the heart of technological innovation, setting a new benchmark for tailored communication in the digital age.

### Message Distribution Systems and Methods

In the contemporary realm of real estate and other application technology, ensuring effective communication is of paramount importance. Traditional communication methods, typified by mass-sent messages and generic notifications, often fall short in providing the precision and immediacy crucial for ideal client-agent interactions. The optimal solution should adjust its communication based on the dynamic profiles and evolving requirements of each client, fostering synchronization between clients, agents, and the referral companies throughout the entirety of their real estate and other relevant journey. The capabilities (e.g., provided in segments and/or modules) include the following:

The Message Distribution System embodiments comprise an avant-garde communication structure tailored to streamline and individualize messages among the platform, agents, clients, and the referring company. This system, using a vast reservoir of data points, which includes dynamic client profiles and instantaneous updates, ensures communications remain contextually pertinent, timely, and actionable.

Benefits from these embodiments include:
1. Referral Company Engagement: Traditionally, once a client referral is made, the referring company often loses touch with the client. With embodiments of this invention, the referring company remains integrally involved, guiding the client through their real estate and other relevant journey and ensuring the agent provides exemplary service. The system, thereby, bridges any engagement gap that might exist between the client and the referral company post the initial referral.
2. Proactive Support: Embodiments of this invention enable internal support teams to access real-time client data. This proactive approach ensures that any emerging issues are rapidly identified and addressed, enhancing the service quality experienced by clients. Moreover, when necessary, these embodiments promote engagement by the internal support team, further buttressing the quality of service clients receive.
3. Contextual Relevance: The Message Distribution System, unlike generic notifications, crafts every communication to mirror the client's current position, activities, and necessities. This specificity guarantees clients garner insights and recommendations germane to their current stage in the real estate and other relevant progression.
4. Real-time Engagement: As clients transition through phases, such as aligning with a mortgage provider, the system acknowledges these shifts instantaneously. This reactive nature ensures the communication mirrors the client's most recent status and needs.
5. Enhanced Client-Agent Synchronization: The system keeps agents apprised of the messages dispatched to their clients, ensuring they remain informed and can align their strategies effectively with the platform's communications.
6. Efficiency and Reduced Redundancy: The system eschews sending unnecessary or repetitive messages, sparing clients from information deluge. This efficiency boosts client engagement rates, with clients appreciating the consistent relevance and value of the communications they receive.
7. Dynamic Adaptability: The system's innate ability to adapt means that as real estate and other relevant market dynamics shift or new services emerge, the Message Distribution System can smoothly assimilate these modifications.
8. Improved Client Satisfaction: The punctual and tailored messaging approach augments the likelihood of clients feeling valued and comprehended, amplifying their trust in the platform, agents, and referring company.
9. Uniqueness: Numerous platforms employ messaging systems, but embodiments of the Message Distribution System distinguish themselves with their adaptability and pledge to relay contextually apposite communications. This system extends beyond rudimentary notifications, utilizing a profound grasp of each client's dynamic profile and their real-time actions, a hallmark unique to this invention.

The embodiments of the Message Distribution System herald a transformative advancement in real estate and other relevant technological communication approaches. By ensuring perennial congruence among messages, client requirements, agent actions, and the referring company's objectives, the system confers unparalleled advantages, including client satisfaction and synergy among all stakeholders. Its ground-breaking approach to dynamic and context-sensitive communication should set the industry's gold standard, spotlighting the system's potential to revolutionize real estate and other relevant engagements in this digital epoch.

### Varied Report Types

In the realm of real estate and other applications, effective communication goes beyond mere transmission of information. It's about presenting data in a manner that resonates, educates, and engages clients and agents. Traditional systems have relied heavily on singular modes of data representation, often failing to account for diverse user preferences and learning modalities. The demand is for a versatile platform that employs a variety of report types tailored to the unique needs and preferences of its users. The capabilities (e.g., provided in segments and/or modules) include the following:

Embodiments of the Varied Report Types transcend conventional communication barriers by embracing a multifaceted approach to report generation and dissemination. Recognizing the varied informational needs and consumption habits of its user base, these embodiments seamlessly integrate both static (like PDFs) and dynamic (like videos) report formats, tailored for different contexts and audiences.

Benefits from these embodiments may include:
1. Adaptive Learning Modes: Understanding that users assimilate information differently, embodiments offer both visual (videos) and textual (PDFs) formats. This caters to diverse learning styles, ensuring broader comprehension and engagement.
2. Comprehensive Data Representation: While PDF files offer the advantage of structured, printable data ideal for detailed analysis, videos can present complex concepts in an easily digestible and engaging manner. Together, they provide a holistic view of the information.
3. Enhanced Engagement: Dynamic videos, with their interactive potential, can captivate users, ensuring key messages are conveyed effectively. This boosts engagement rates and ensures users are more likely to act on the insights provided.
4. Flexibility in Information Consumption: Users can choose their preferred mode based on their current needs. Whether they're in a rush and prefer a quick video summary or have time to delve into a detailed PDF report, these embodiments cater to their varied paces and preferences.
5. Efficient Resource Allocation: By analyzing user interaction with varied report types, these embodiments can refine its content strategy, ensuring resources are channeled into producing the most effective report formats for different scenarios.
6. Improved Decision-making: With richer insights and varied perspectives afforded by multiple report formats, clients and agents are better equipped to make informed decisions.
7. Accessibility and Portability: PDFs offer the benefit of easy sharing, printing, and offline access, ensuring users can reference the data even without an active internet connection. On the other hand, videos can be streamed across devices, ensuring accessibility on-the-go.
8. Uniqueness: While many platforms offer report generation capabilities, these embodiments stand out with its integrated approach to varied report types. Its recognition of the value of diverse content formats, tailored to individual user needs, is a distinguishing feature. The system's capability to adapt and present information in the most effective format for a given context is a testament to its innovative design.

The Varied Report types feature within embodiments of this invention exemplifies the next frontier in real estate and other relevant communication strategies. By leveraging multiple formats to present, educate, and engage, these embodiments ensure a more holistic, adaptable, and user-centric approach to information dissemination. This innovative multi-format strategy underscores the invention's commitment to optimizing user experience, engagement, and decision-making in the real estate and other relevant sector.

### The ‘Tell Us’ Embodiments

The, sector's, as well as other application sector's digital evolution, while revolutionary, often risks distancing the core understanding derived from ground-level interactions and experiences. Recognizing the invaluable insights brought forth by agents, embodiments of this invention include the ‘Tell Us’ feature. Unlike the conventional reliance on Artificial Intelligence, this innovation emphasizes Community Intelligence, harnessing insights directly from an expansive community of agents. The principal aim is to align technological solutions more closely with the real-world nuances of the real estate and other relevant industry. The capabilities (e.g., provided in segments and/or modules) include the following:

Bridge between Agents and Developers: ‘Tell Us’ serves as a unique communication portal, bridging the gap between agents, who are the front-line users, and system developers. This ensures that the underlying technology remains in sync with real estate's (and other relevant industry's) ever-evolving demands, ensuring its efficacy and relevance.

Accountability Framework: The feature introduces an enhanced accountability system. In instances where agents identify discrepancies or inaccuracies, ‘Tell Us’ offers a streamlined mechanism for them to highlight and rectify these issues, reaffirming the invention's commitment to clarity and accuracy.

User-Friendly Interface: Integrated directly into the agent's dashboard, feedback initiation is effortless. Upon selecting the ‘Tell Us’ option, the interface automatically populates client-specific data, such as name, ID number, and other details. This ensures that feedback is not only precise but is also contextual, linked directly to specific client profiles.

Structured Feedback System: To pinpoint concerns, agents can indicate the exact step and phase in question. A severity dropdown further categorizes the issue, ensuring that the feedback is both comprehensive and categorized.

Detailed Insights: Beyond structured feedback, a designated space allows agents to provide a narrative, detailing concerns, or suggesting potential improvements. This ensures that while technology underpins the feature, the human perspective remains paramount.

Prompt Integration: Once feedback is submitted, it's instantly integrated into a dedicated ‘Tell Us’ database, reinforcing the platform's commitment to responsiveness and continuous improvement.

Aggregated Analysis: The individual feedback pieces are aggregated to form the Health Report. This isn't just an overview but provides a granular understanding of potential issues, categorized by sectors and their severity. It functions as an instantaneous diagnostic tool, providing clarity on areas needing attention.

Customized Exploration: While the Health Report offers a macro perspective, developers have the flexibility to delve deeper, creating custom reports that explore specific feedback areas more intricately.

The ‘Tell Us’ feature, conceptualized and developed as part of this invention, represents a groundbreaking innovation in the real estate and other relevant technological domain. By harmoniously blending precise technology with the experiential wisdom of agents, it ensures that the digital platform remains anchored to the realities of the real estate and other relevant market. This alignment not only enhances the user experience but also ensures that the platform remains at the forefront of the industry's evolving demands, delivering an experience that's both state-of-the-art and deeply rooted in human insights.

### EXAMPLES

The subject matter of this disclosure is now described with reference to the following examples set forth in the figures. These examples are provided for the purpose of illustration only, and the subject matter is not limited to these examples, but rather encompasses all variations which are evident as a result of the teaching provided herein.

### System Diagram

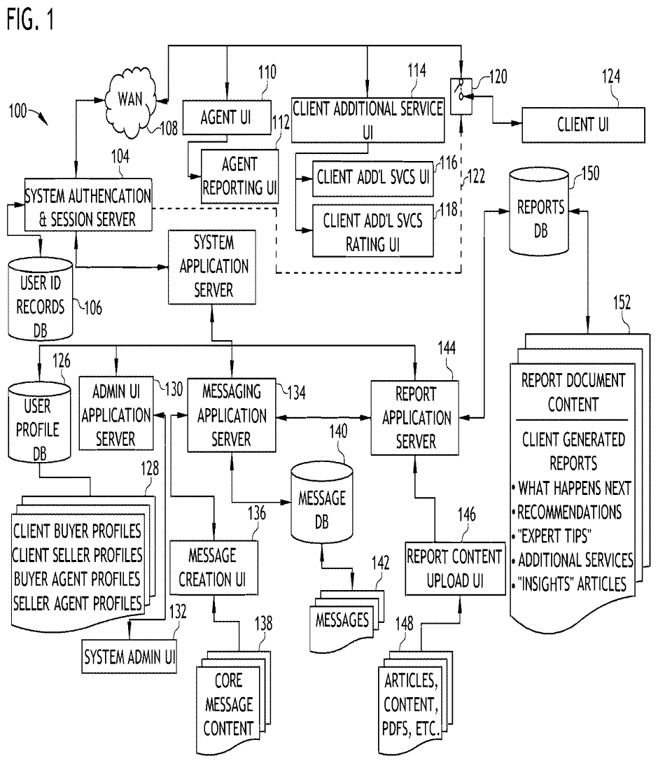

FIG. 1 illustrates a schematic diagram of a first embodiment of a system 100 disclosed herein. The system 100 has various connections, including to a Wide Area Network (WAN) 108, an Agent User Interface (UI) 110, Client Additional Services User Interface (UI) 114 and to a Client User Interface (UI) 124 controlled by a switch 120. A System Authentication & Session Server 104 is also connected to the WAN 108, the switch 120, a System Application Server 102 and User Identification (ID) and Record Database (DB) 106. Additional databases (126, 140, 150), servers (130, 134, 144), user interfaces (112, 116, 118, 132, 136, 146), interact to store and retrieve profiles 128, messages 138, articles and other content 148, and reports 152.

### System Method Diagram

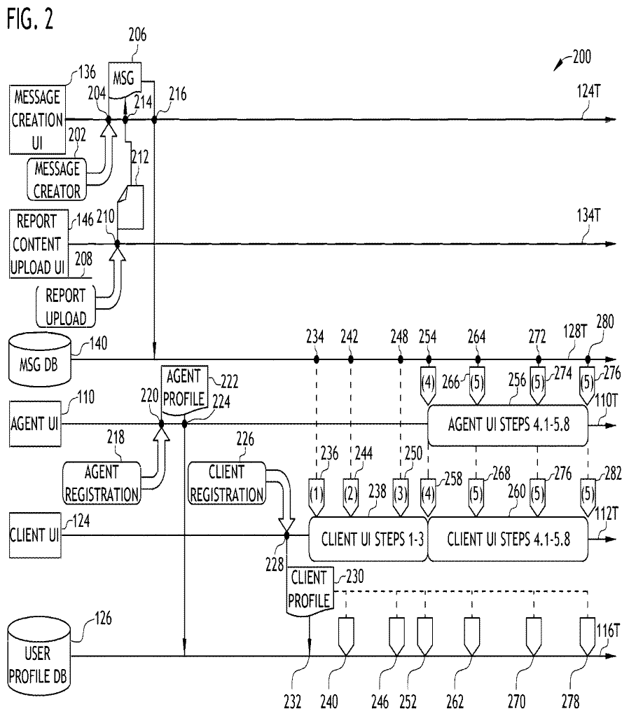

FIG. 2 illustrates a schematic diagram 200 of a time-based method of user interactions on multiple system user interfaces within the system and their interaction with a message database 140 and a profile database 125. User interfaces (UI) are identified (136, 146, 110, 124), that are used with message creation 202, report uploading 208, agent registration 218, and client registration 226 to create messages 206, upload reports 212, create agent profiles 222, and create client profiles 230.

### User Profiles: Agent User Profile Creation

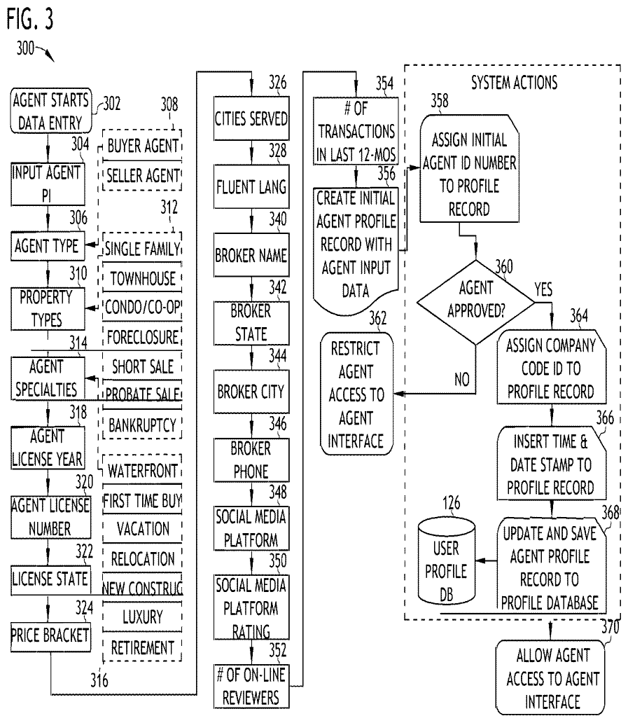

FIG. 3 illustrates a schematic logical diagram 300 of a method of creating an agent profile that will be stored in a profile database 126. Various data is input and collected (302 through 356), the agent is evaluated 360 and if approved allowed further access (364, 366, 368, 370). If not approved, the agent is restricted from access 362.

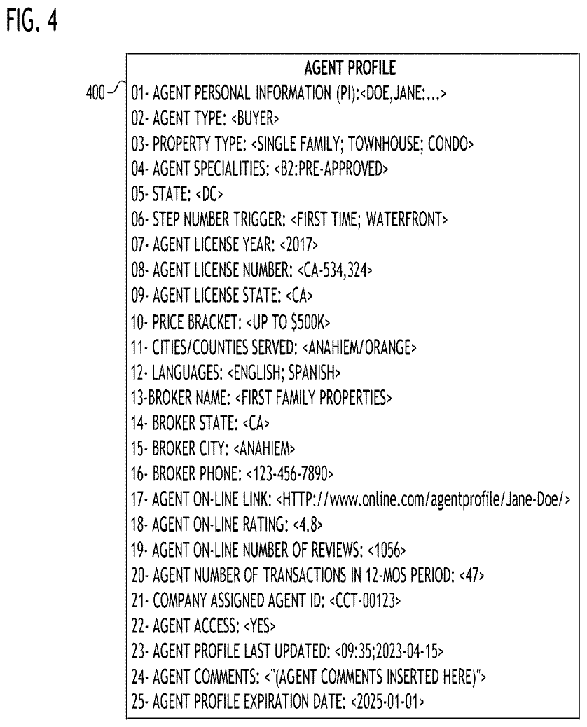

FIG. 4 illustrates a Agent User Profile 400 example, with types of information that may be input and collected (01 through 25).

### User Profiles: Client User Profile Creation

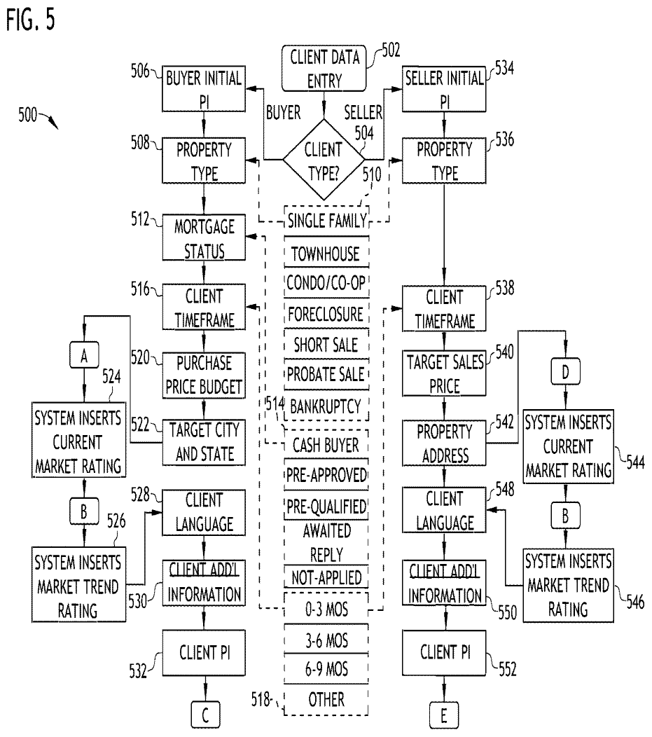

FIG. 5 illustrates a schematic logical diagram 500 of a method of creating both a buyer client profile record 532 and a seller client profile record 552 that will be stored in a profile database. The client data entry 502 begins with determining whether a client is a buyer or a seller 504. If a buyer, information is collected and input (506 through 532). If a seller, information is also collected and input (534 through 552).

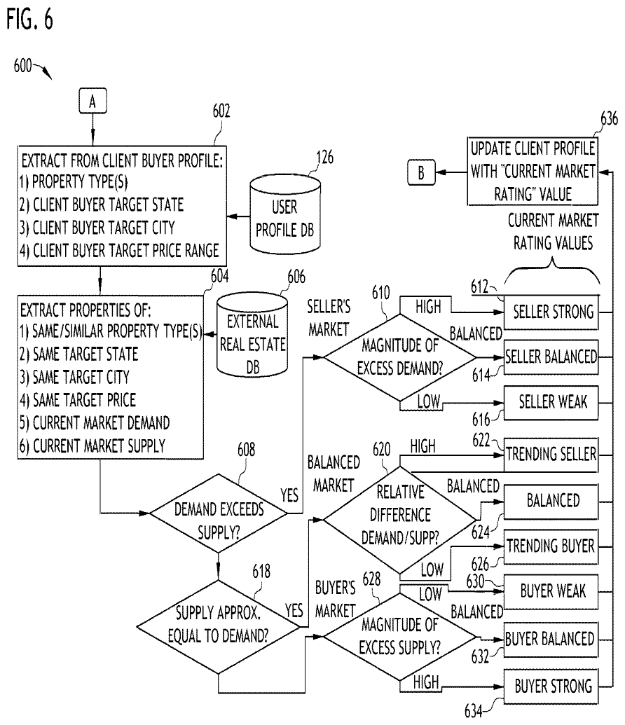

FIG. 6 illustrates a schematic logical diagram 600 of a method of determining and assigning a current market rating value for a buyer client within the schematic logical diagram of the method of creating the buyer client profile record of FIG. 5. The buyer's client profile is updated with a “current market rating” value 636 from collection and input of data from databases (126, 606) and making decisions on supply and demand (608, 610, 618, 620, 628) and the strength and weaknessess of buyers and sellers (612 through 634).

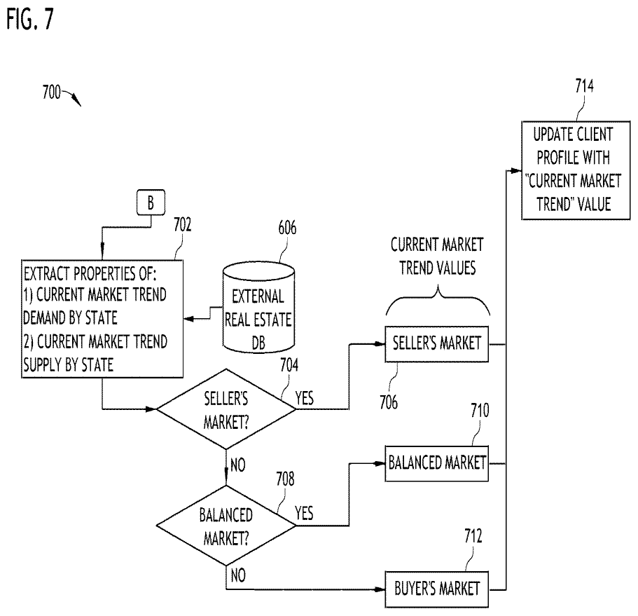

FIG. 7 illustrates a schematic logical diagram 700 of a method of determining and assigning a current market trend value for either a buyer client or a seller client within the schematic logical diagram of the method of creating both the buyer profile record and the seller profile record of FIG. 5. The client profile is updated with a “current market trend” value 714 from collection and input of data from databases (606, 702) and making decisions on trends (704, 708) and the trends in the market (706, 710, 712).

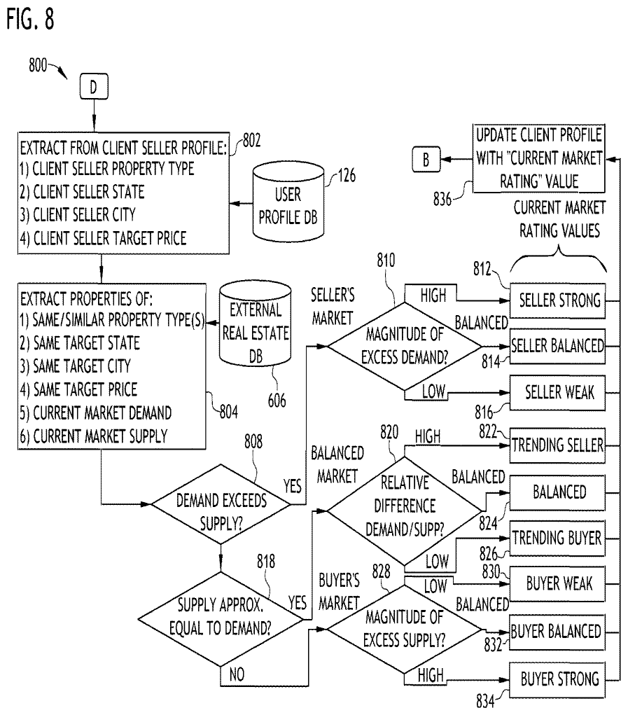

FIG. 8 illustrates a schematic logical diagram 800 of a method of determining and assigning a current market rating value for a seller client within the schematic logical diagram of the method of creating the seller client profile of FIG. 5. The client profile is updated with a “current market rating” value 836 from collection and input of data from databases (126, 606, 802, 804) and making decisions on trends (808, 818) and the trends in the market (810, 820, 828, 812 through 834).

FIG. 9 illustrates a continuation of the schematic logical diagram 900 of the method of creating both the buyer profile record and the seller profile record that will be stored in the profile database 126 of FIG. 5. The system's tasks on the buyer side (908 through 924) as well as the seller side (928 through 940) are shown. In embodiments using the open-access engagement tools and taking a privacy centric approach, certain client personal information is not taken or recorded (e.g., contact information), at least initially, instead focusing the process on user input preferences, such as budget, location, property type, etc., as explained further above.

### User Profiles: Exemplary Buyer Client User Profile

FIG. 10 illustrates an exemplary buyer client profile record 1000 created by the method of FIGS. 5-7 and 9, with types of information that may be input and collected or system populated (01 through 31).

In particularly preferred examples, a privacy-centric approach is used and the open-access engagement tools and anonymized data tracking using a code (e.g., 12-digit) as described herein are applied, instead of requesting certain of the more intrusive buyer information set forth in FIG. 10.

FIG. 11 illustrates an exemplary seller client profile record 1100 created by the method of FIGS. 5 and 7-9, with types of information that may be input and collected or system populated (01 through 31).

### User Interfaces: Buyer Agent User Interface

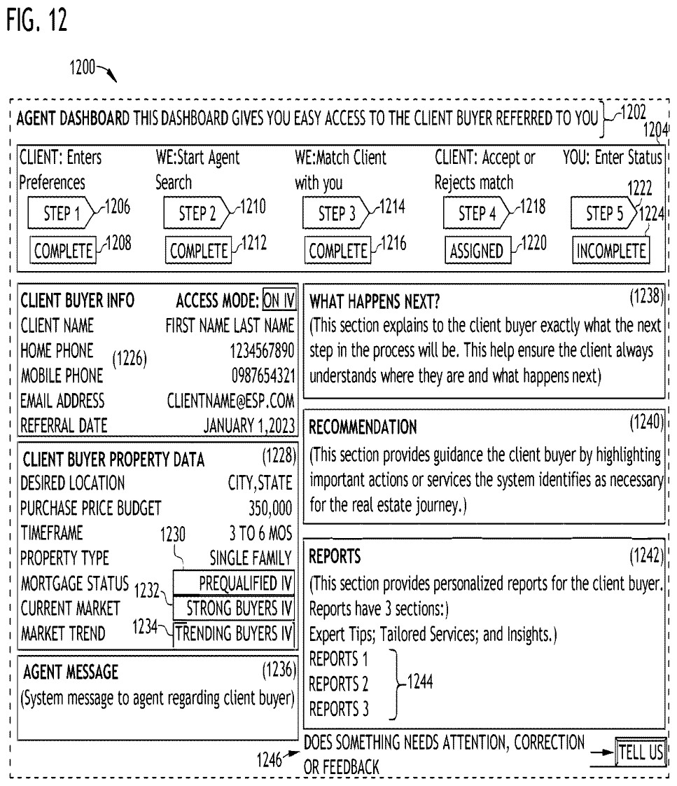

FIG. 12 illustrates a buyer agent user interface 1200. Sections of the Agent Dashboard 1202 include progress on steps taken 1204 (1206 through 1224), Client Buyer Info 1226, Client Buyer Property Data 1228, Agent Message 1236, What Happens Next? 1238, Recommendation 1240, Reports 1242, 1244, and whether something needs attention 1246.

### User Interfaces: Seller Agent User Interface

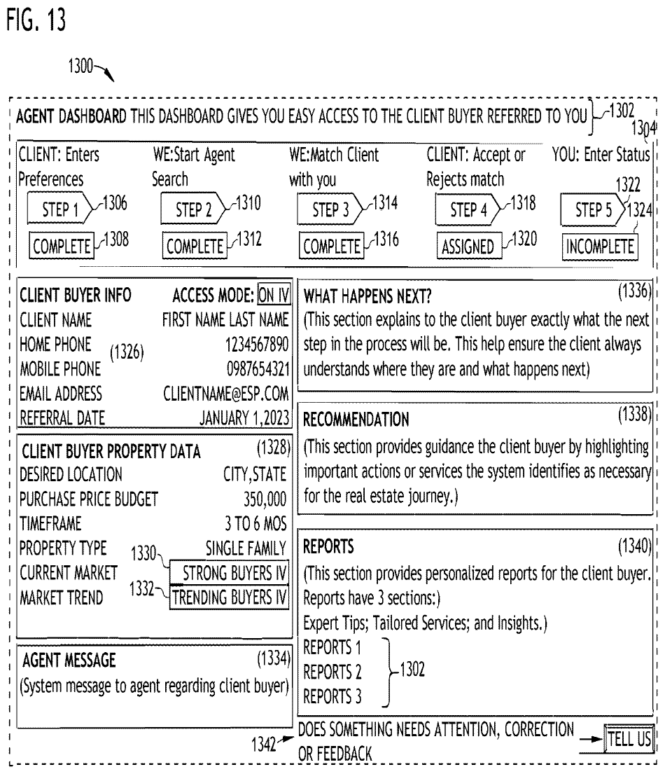

FIG. 13 illustrates a seller agent user interface 1300. Sections of the Agent Dashboard 1302 include progress on steps taken 1304 (1306 through 1324), Client Seller Info 1326, Client Seller Property Data 1328, Agent Message 1334, What Happens Next? 1336, Recommendation 1338, Reports 1340, 1302, and whether something needs attention 1342.

### User Interfaces: Buyer Client User Interface

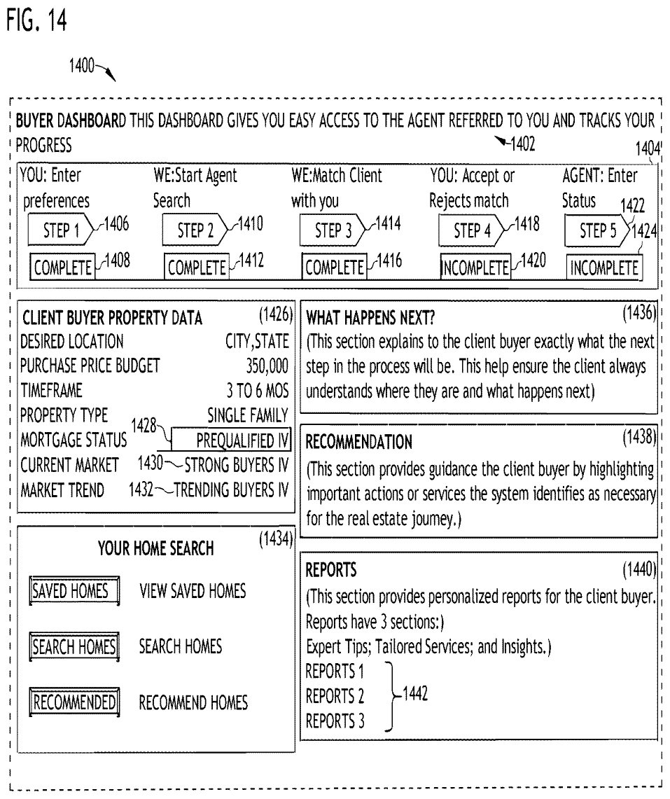

FIG. 14 illustrates a buyer client user interface 1400. Sections of the Buyer Dashboard 1402 include progress on steps taken 1404 (1406 through 1424), Your Information 1426, Your Home Search 1434, What Happens Next? 1436, Recommendation 1438, and Reports 1440, 1442.

### User Interfaces: Seller Client User Interface

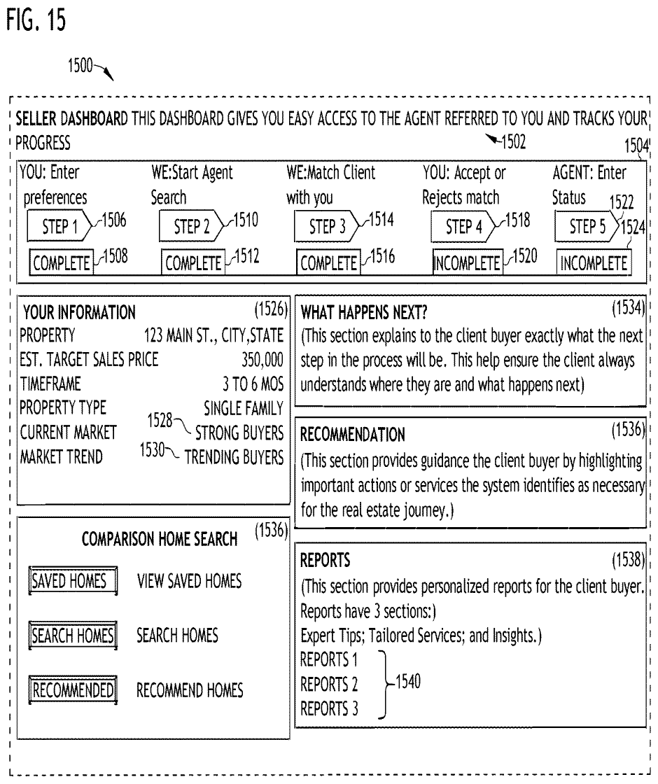

FIG. 15 illustrates a seller client user interface 1500. Sections of the Seller Dashboard 1502 include progress on steps taken 1504 (1506 through 1524), Your Information 1526, Comparison Home Search 1532, What Happens Next? 1534, Recommendation 1536, and Reports 1538, 1540.

### User Interfaces: Client Agent Rating and Performance User Interface

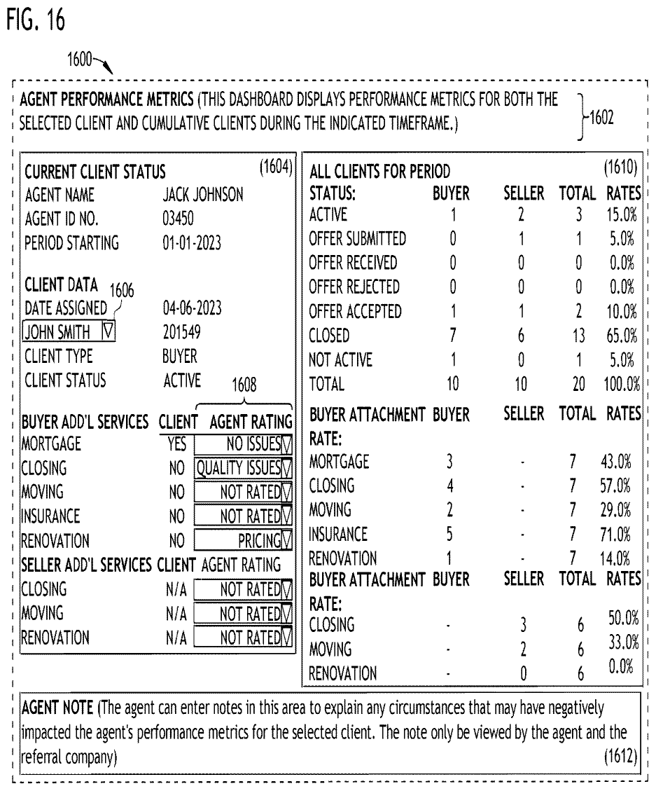

FIG. 16 illustrates an agent rating and performance metrics user interface 1600. Sections of the Agent Performance Metrics (dashboard) 1602 include Current Client Status and Client Data 1604 as well as Buyer Add'l Services and Seller Add'l Services and Agent Rating 1608. Additional sections include All Clients For Period 1610 data and an Agent Note 1612 field.

### User Interfaces: Additional Client Services Provider User Interface

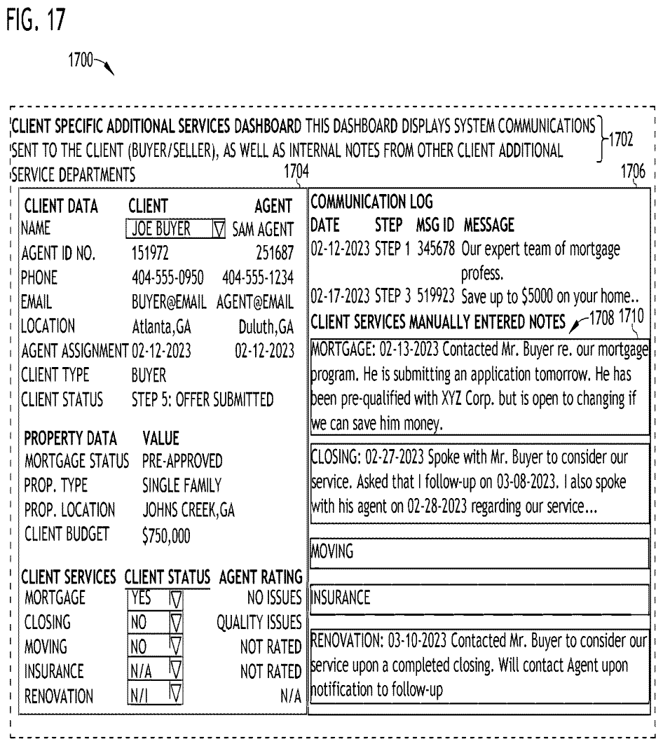

FIG. 17 illustrates an additional client services provider user interface 1700. Sections of the Client Specific Additional Services Dashboard 1702 include Client Data/Client/Agent, Property Data/Value, and Client Services/Client Status/Agent Rating 1704, as well as a Communication Log 1706 and Client Services Manually Entered Notes 1708, 1710.

### User Interfaces: Additional Client Services Provider Cumulative Ratings User Interface

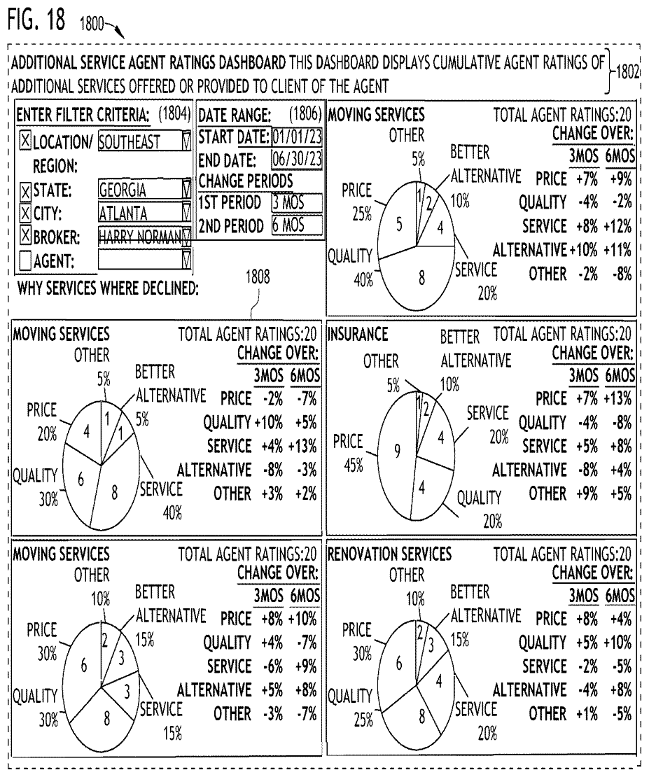

FIG. 18 illustrates an additional client services provider cumulative ratings user interface 1800. Sections of the Additional Services Agent Ratings Dashboard 1802 include Filter Cirteria 1804 and Date Range 1806, Why Services Were Declined 1808 (Mortgage Services 1810, Closing Services 1812, Moving Services 1814, Insurance 1816, and Renovation Services 1818).

### Messages: Building a Message Record

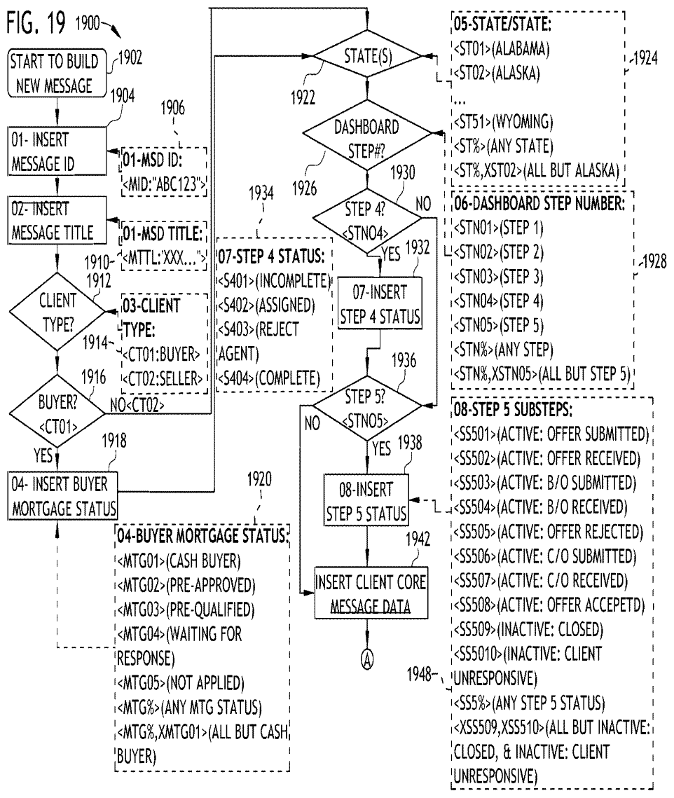

FIG. 19 illustrates a schematic logical diagram 1900 of a first embodiment of a method of building a message record that is stored in a message database. The types of information that is collected and input is shown (e.g., steps 01 through 08) as well as decisions (1912, 1916, 1922, 1926, 1930, 1936) are shown.

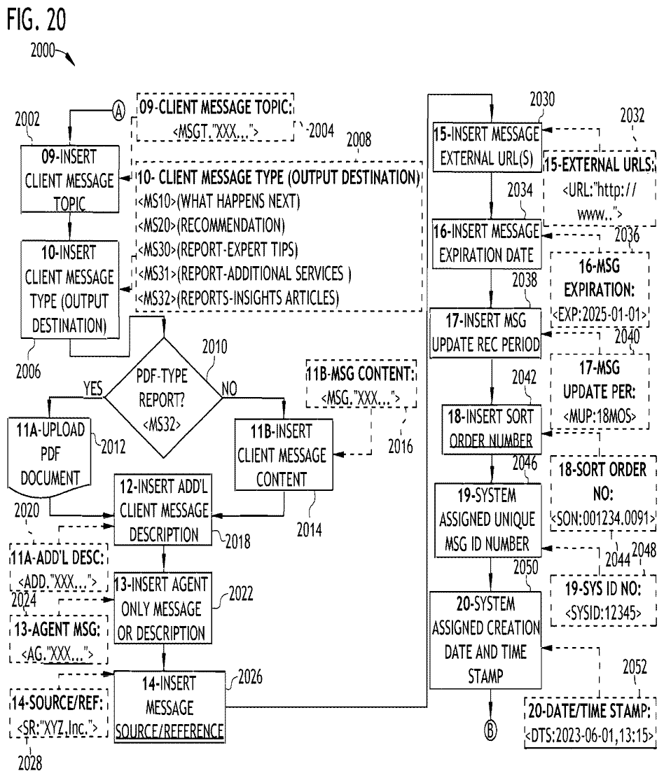

FIG. 20 illustrates a continuation of the schematic logical diagram 2000 of the first embodiment of the method of building the message record of FIG. 19. Steps 09 through 20 are shown.

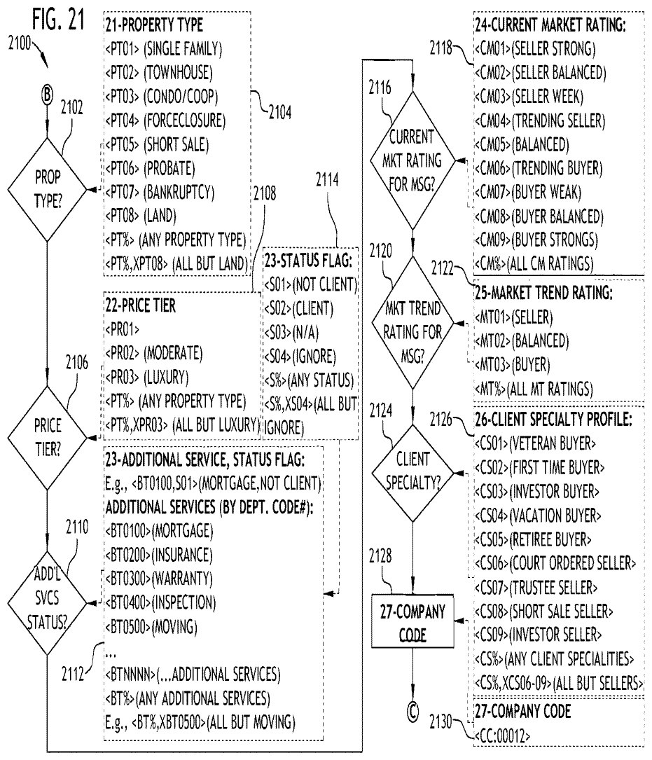

FIG. 21 illustrates a further continuation of the schematic logical diagram 2100 of the first embodiment of the method of building the message record of FIGS. 19-20. Steps 21 through 27 are shown.

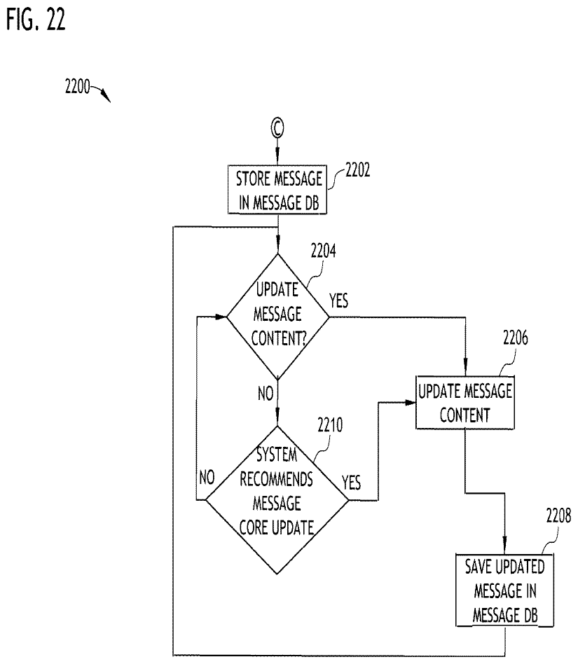

FIG. 22 illustrates a further continuation of the schematic logical diagram 2200 of the first embodiment of the method of building the message record of FIGS. 19-21. The storage of the message in the database 2202 and updating 2204, 2206, 2208, 2210 of such is shown.

### Messages: Examplary Message Record

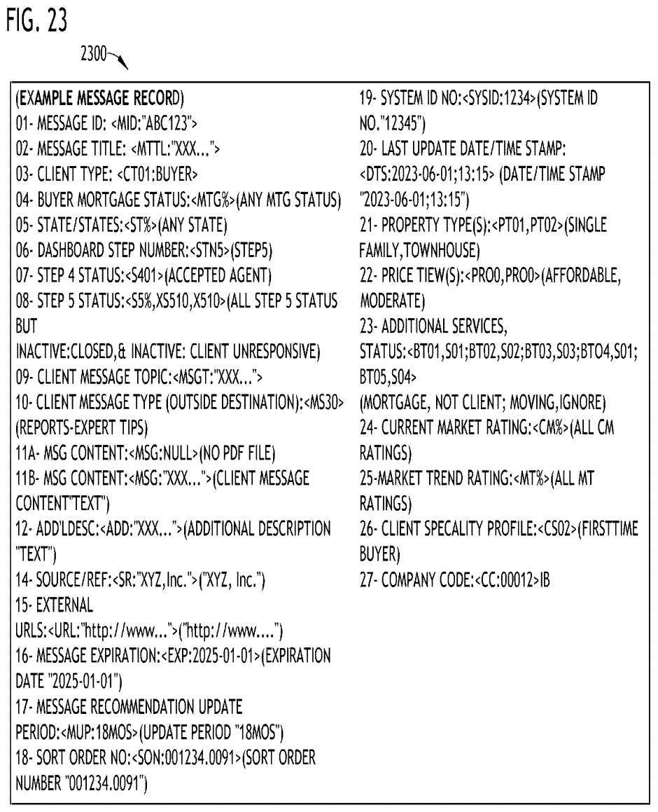

FIG. 23 illustrates an exemplary message record 2300 created by the method of FIGS. 19-22, with types of information that may be input and collected (01 through 27).

### Messages: Message Record Distribution

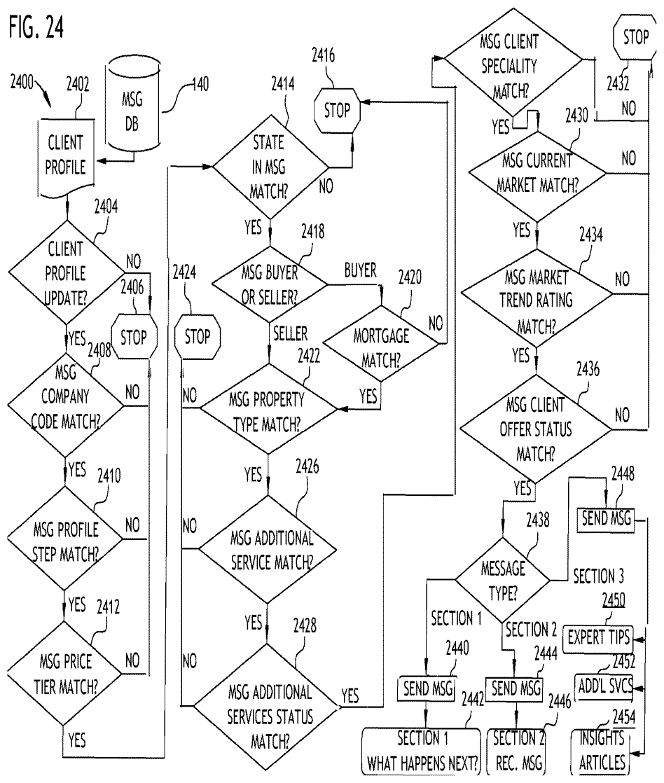

FIG. 24 illustrates a schematic logical diagram 2400 of a method of distributing a stored message record from the message database to one of the three display outputs on the buyer and seller agent user interfaces and buyer client and seller user interfaces.

### Client Transaction Tracking on Client User Interface Transaction Steps 1-4

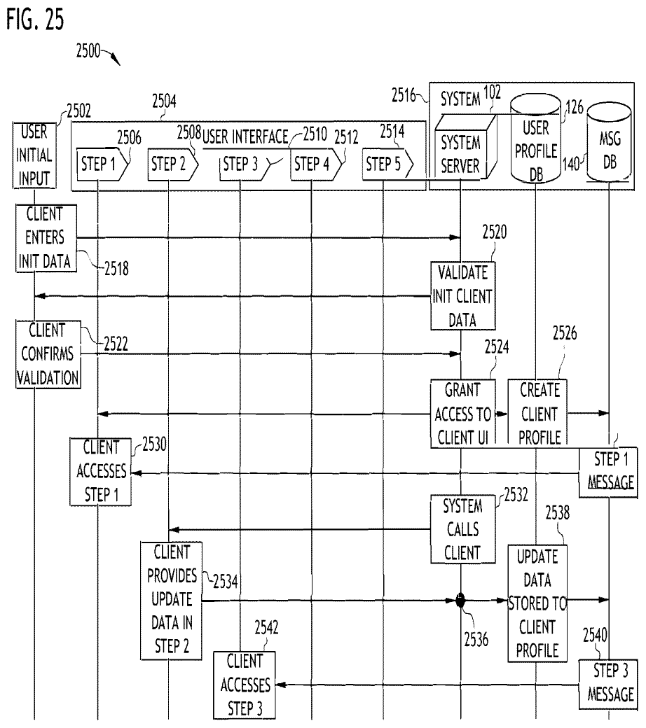

FIG. 25 illustrates a schematic workflow diagram 2500 of a method of client interaction with the system server 102 via the buyer client user interface (of FIG. 14) or the seller client user interface (of FIG. 15) 2504.

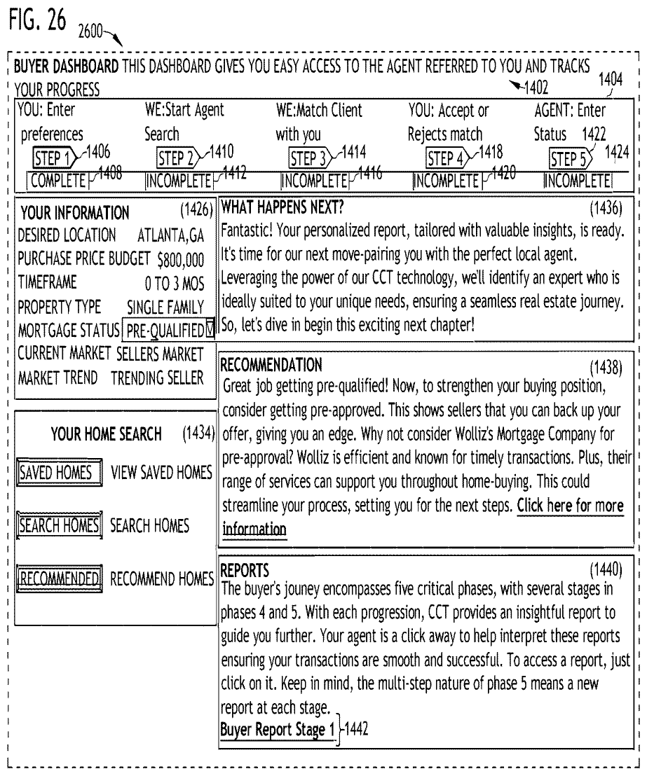

FIG. 26 illustrates an exemplary buyer client user interface 2600 at a first step of the client transactions maintained by the system corresponding to the first step of the user interface 1406 in FIG. 25. The Buyer Dashboard 1402 shows Step 1 is Complete 1408.

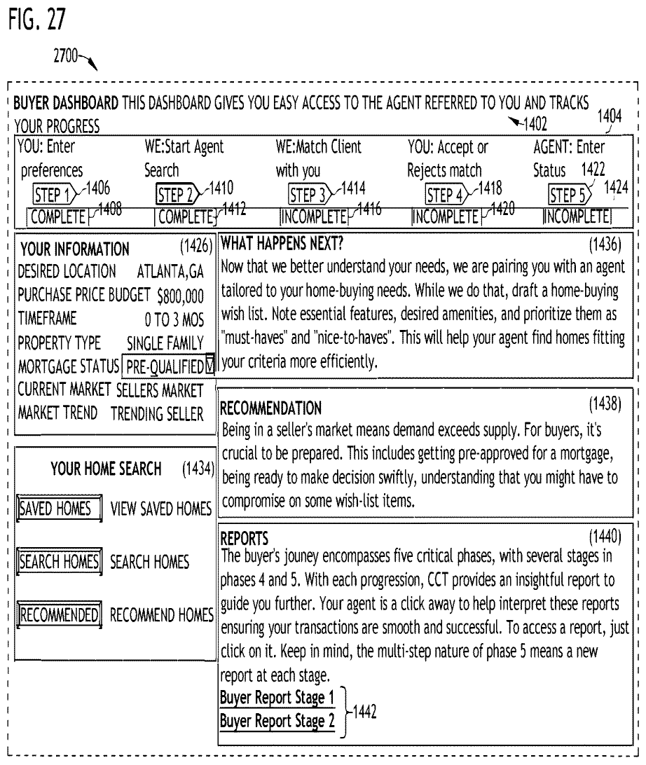

FIG. 27 illustrates an exemplary buyer client user interface 2700 at a second step of the client transactions maintained by the system corresponding to the second step of the user interface 1410 in FIG. 25. The Buyer Dashboard 1402 shows Step 1 is Complete 1408 and Step 2 is Complete 1412.

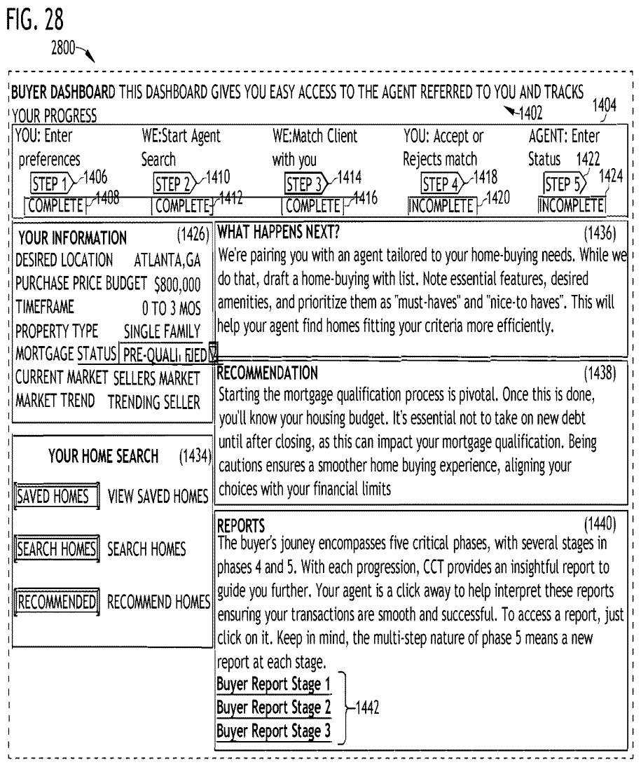

FIG. 28 illustrates an exemplary buyer client user interface 2800 at a third step of the client transactions maintained by the system corresponding to the third step of the user interface 1416 in FIG. 25. The Buyer Dashboard 1402 shows Step 1 is Complete 1408, Step 2 is Complete 1412, and Step 3 is Complete 1416.

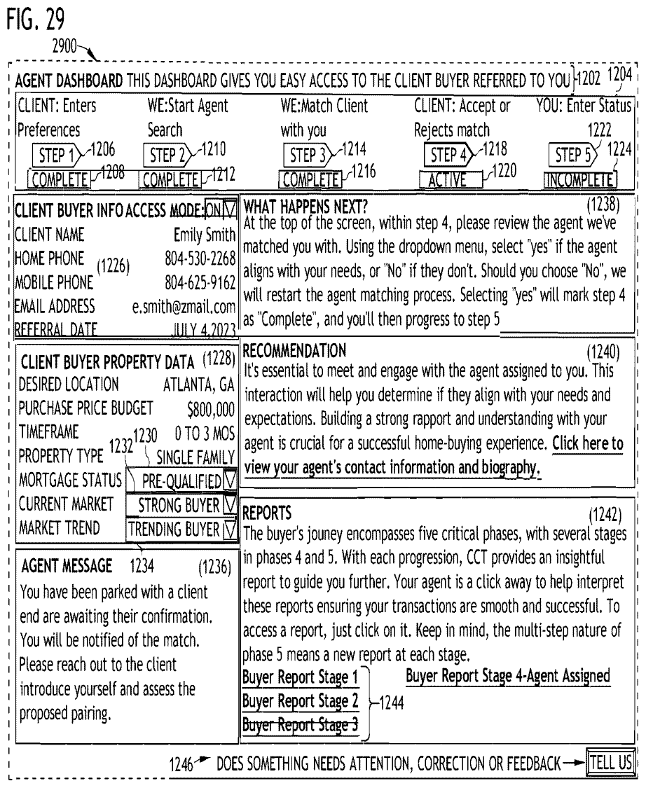

FIG. 29 illustrates an exemplary buyer agent user interface 2900 at a fourth step of the client transactions maintained by the system corresponding to the fourth step 1218 of the user interface 1220 in FIG. 25. The Agent Dashboard 1202 shows Step 1 is Complete 1208, Step 2 is Complete 1212, Step 3 is Complete 1216, and Step 4 is Active 1220.

### Client Transaction Tracking on Client User Interface: Transaction Step 4 Stages

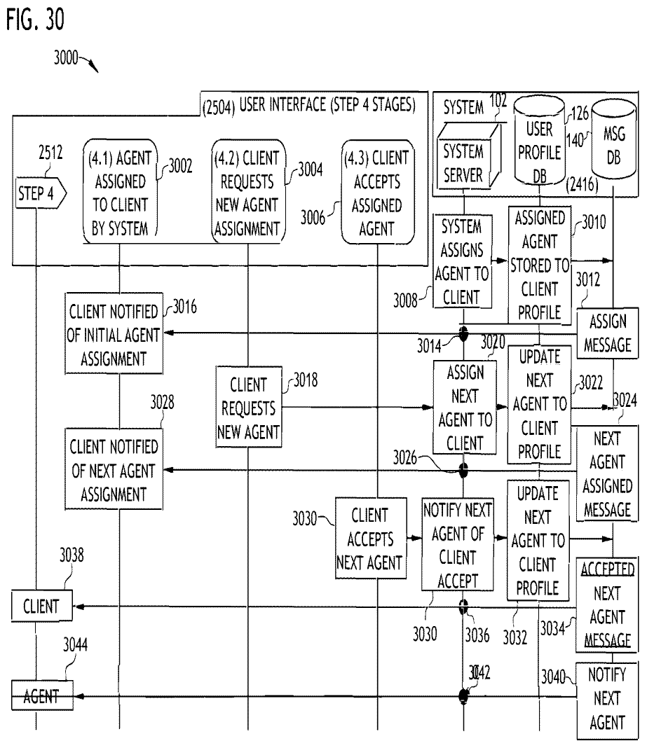

FIG. 30 illustrates a schematic workflow diagram 3000 of the method of client interaction at the fourth step with three stages with the system server via the client user interface.

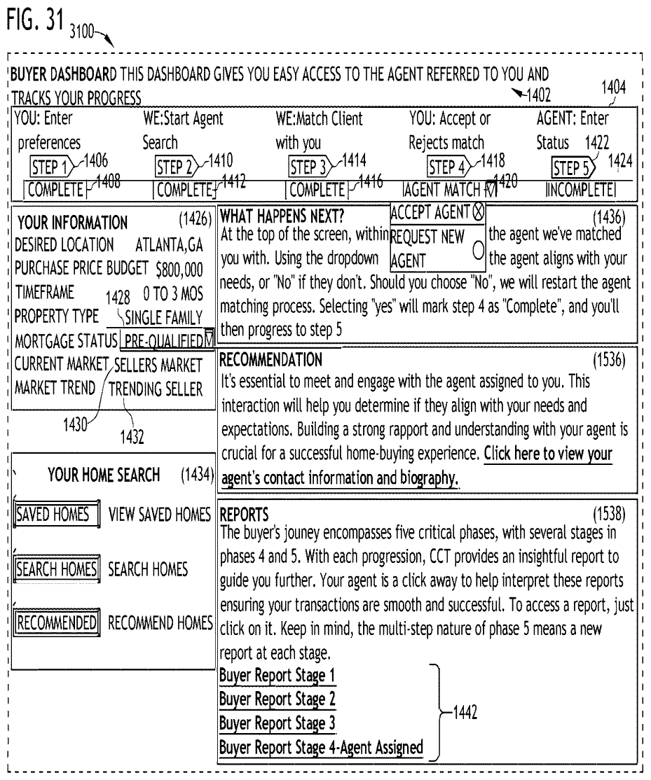

FIG. 31 illustrates an exemplary buyer client at a third stage 3102 of the fourth step 1418 of the client transactions maintained by the system 3100 corresponding to the fourth step of the user interface in FIG. 29.

### Client Transaction Tracking on Client User Interface: Transaction Step 5

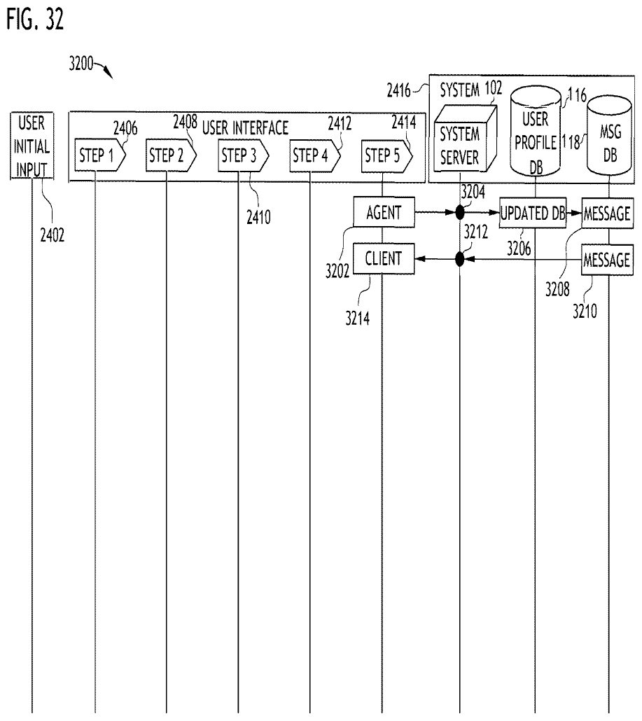

FIG. 32 illustrates a schematic workflow diagram 3200 of the method of agent interaction at the fifth step 2414 with the system server 102 via the agent user interface and the client user interface.

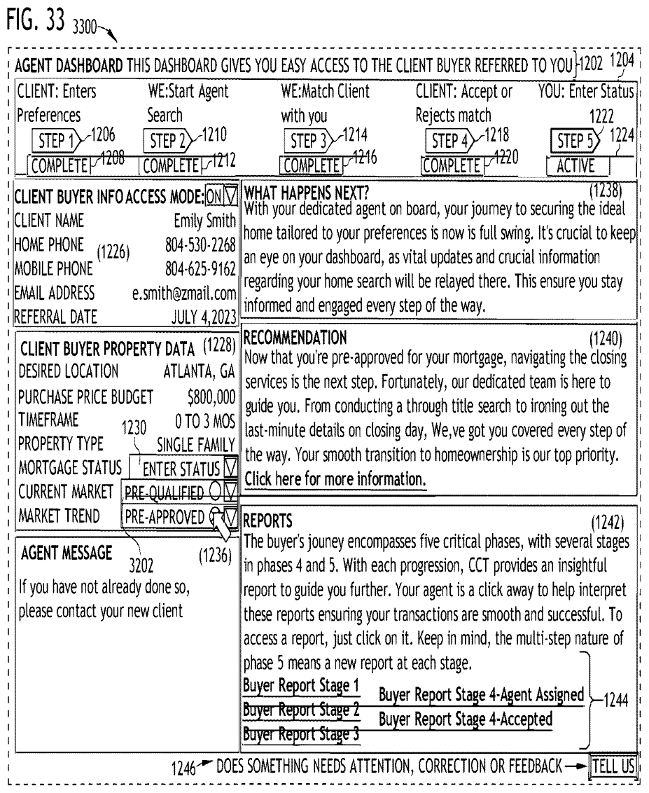

FIG. 33 illustrates an exemplary agent user interface 3300 of a method of a buyer agent updating a mortgage status of the buyer client 3202 according to FIG. 32.

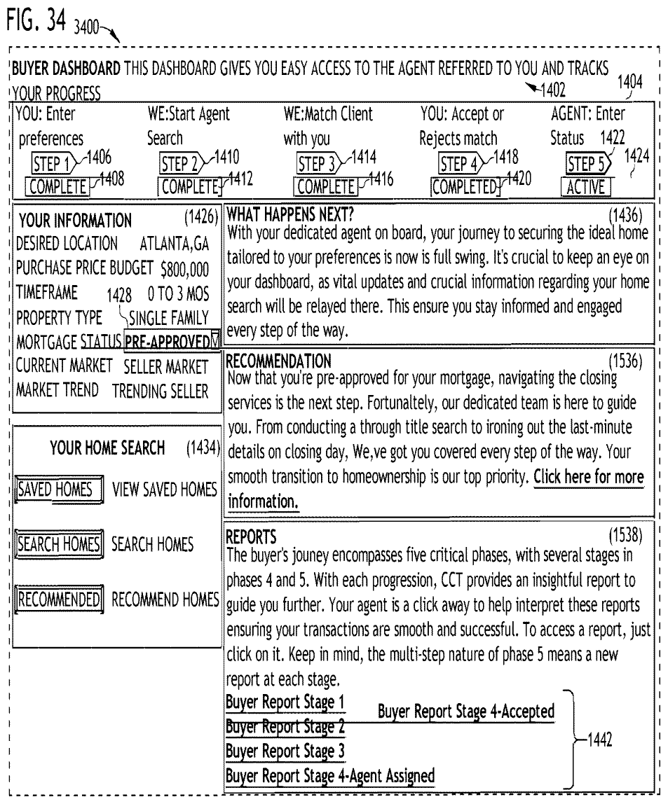

FIG. 34 illustrates an exemplary buyer client user interface 3400 updated in accordance with the action of the buyer agent updating the mortgage status of the buyer client 1428 according to FIG. 32.

### Client Transaction Tracking on Client User Interface: Transaction Step 5 Stages

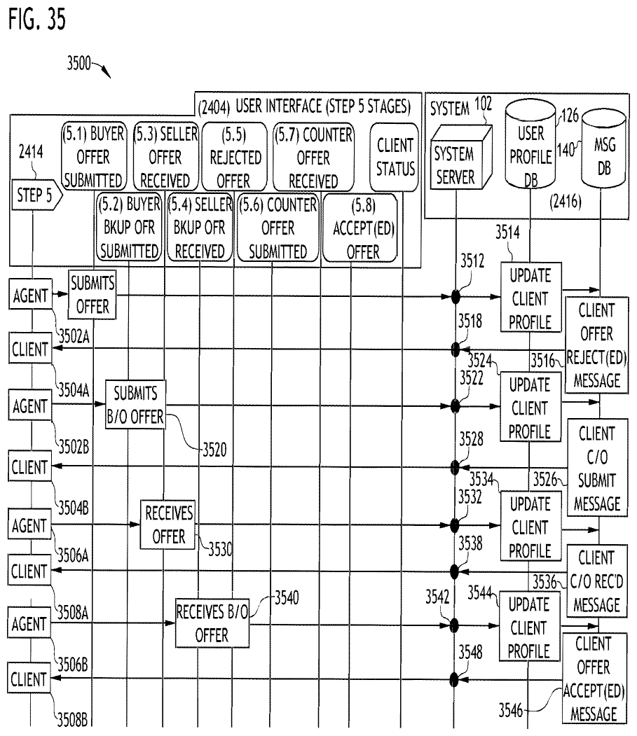

FIG. 35 illustrates a schematic workflow diagram 3500 of a method of client and agent interaction at the fifth step including eight stages and a client status stage with the system server via the buyer client or seller client user interface.

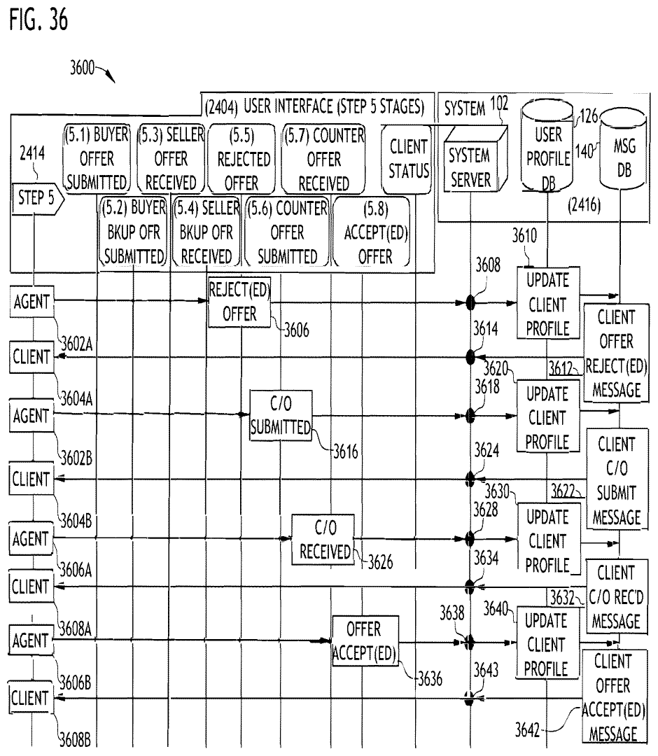

FIG. 36 illustrates continuation of the schematic workflow diagram 3600 of FIG. 35 of the method of client and agent interaction at the fifth step including eight stages and a client status stage with the system server via the buyer client or seller client user interface.

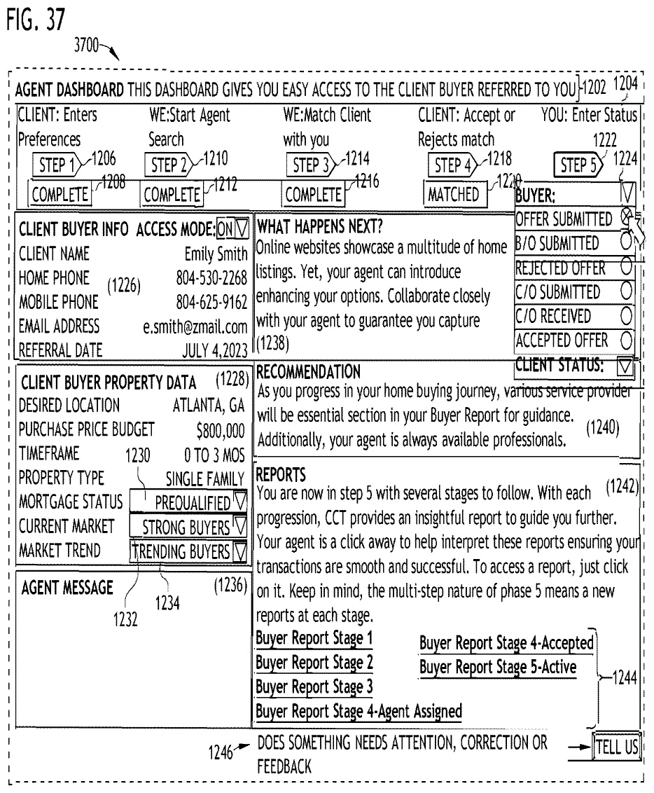

FIG. 37 illustrates an exemplary buyer agent user interface 3700 of a method of the buyer agent selecting a buyer client stage 1224.

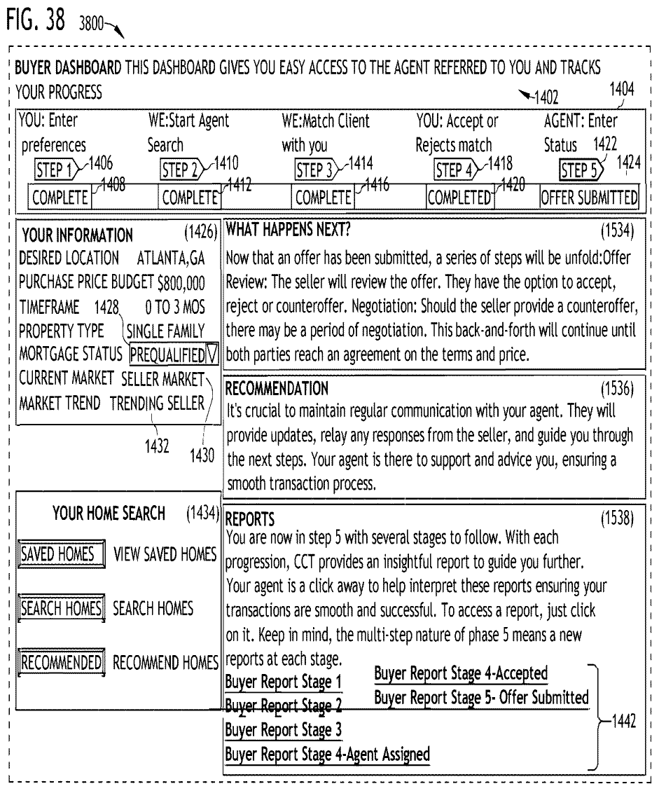

FIG. 38 illustrates an exemplary buyer client user interface 3800 of the method of FIG. 37 indicating the selection of the buyer agent on the buyer agent user interface 1424.

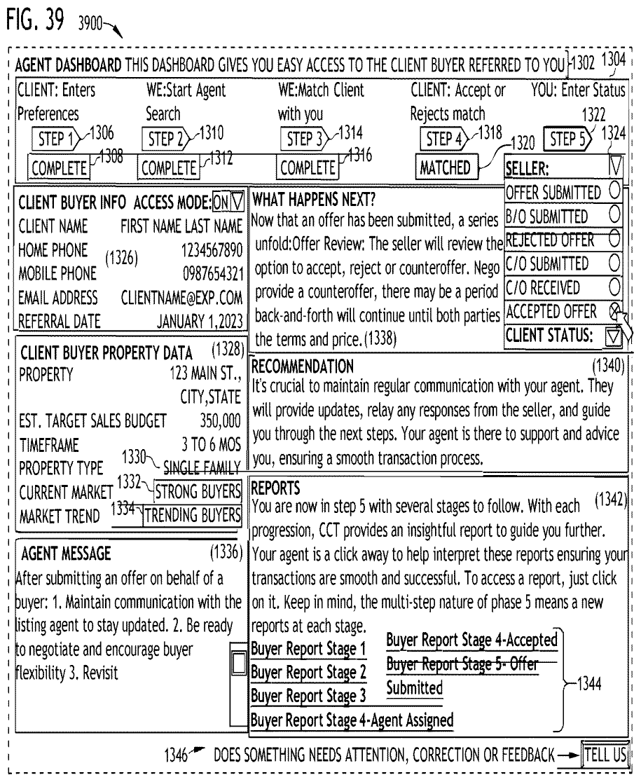

FIG. 39 illustrates an exemplary seller agent user interface 3900 of a method of the seller agent selecting a seller client stage 1324.

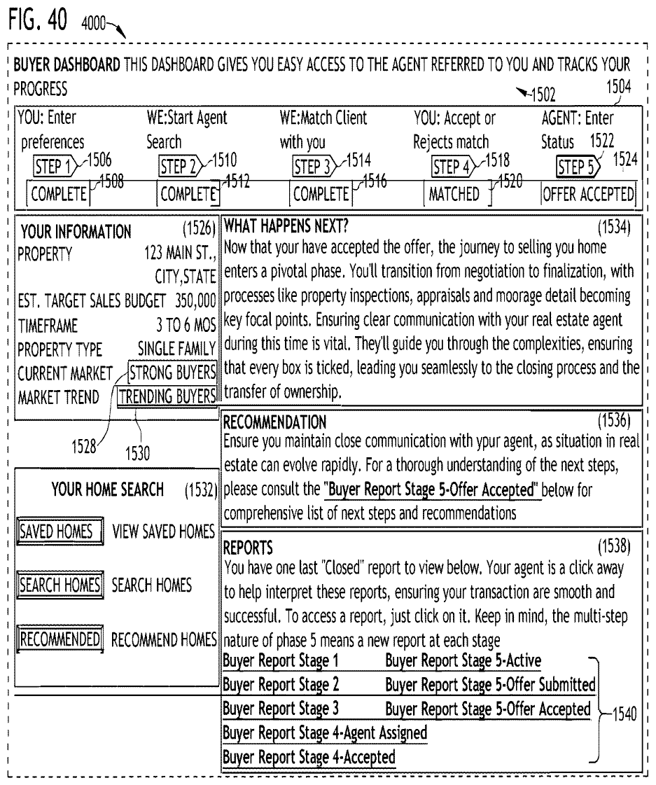

FIG. 40 illustrates an exemplary seller client user interface 4000 of the method of FIG. 39 indicating the selection of the seller agent on the seller agent user interface 1524.

### Client Transaction Tracking on Client User Interface: Transaction Step 5 Client Status

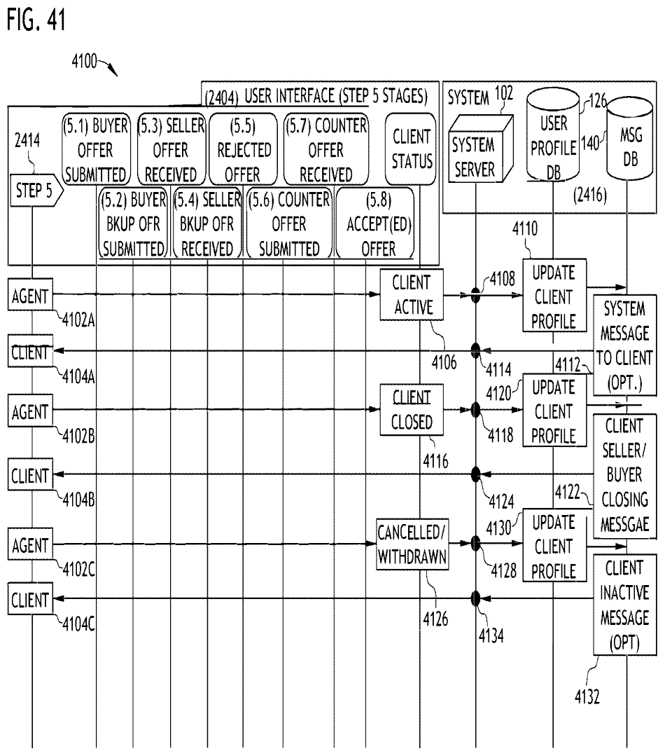

FIG. 41 illustrates continuation of the schematic workflow diagram 4100 of FIGS. 34-35 of the method of client and agent interaction at the fifth step including a client status indicator with the system server via the buyer client or seller client user interface.

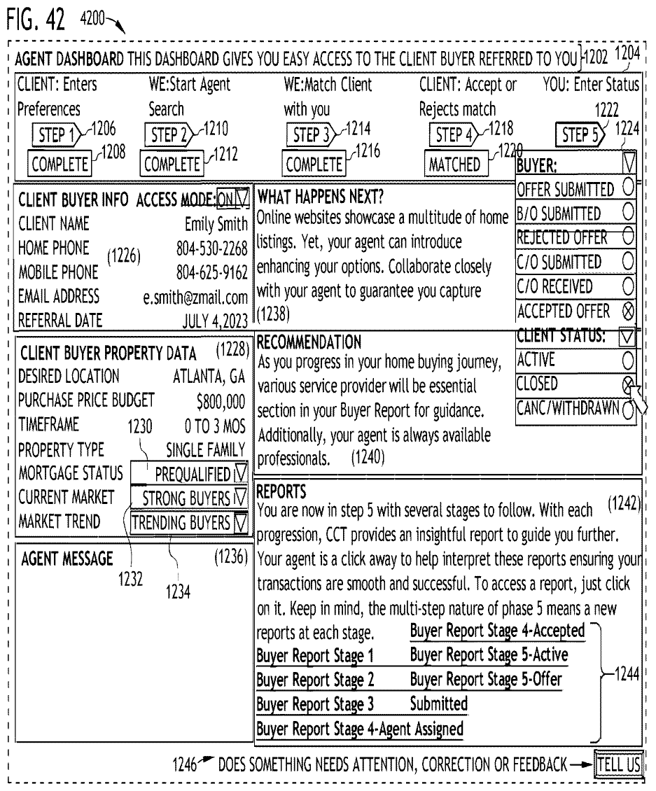

FIG. 42 illustrates an exemplary buyer agent user interface 4200 of a method of the buyer agent selecting a buyer client status 1224.

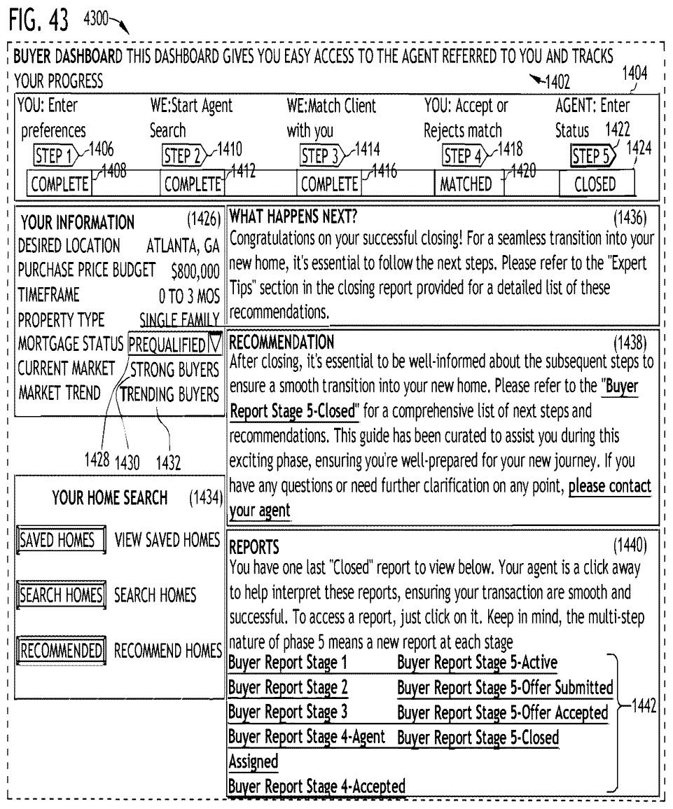

FIG. 43 illustrates an exemplary buyer client user interface 4300 of the method of FIG. 41 indicating the selection of the buyer agent of the buyer client status on the buyer agent user interface 1424.

### Exemplary Report

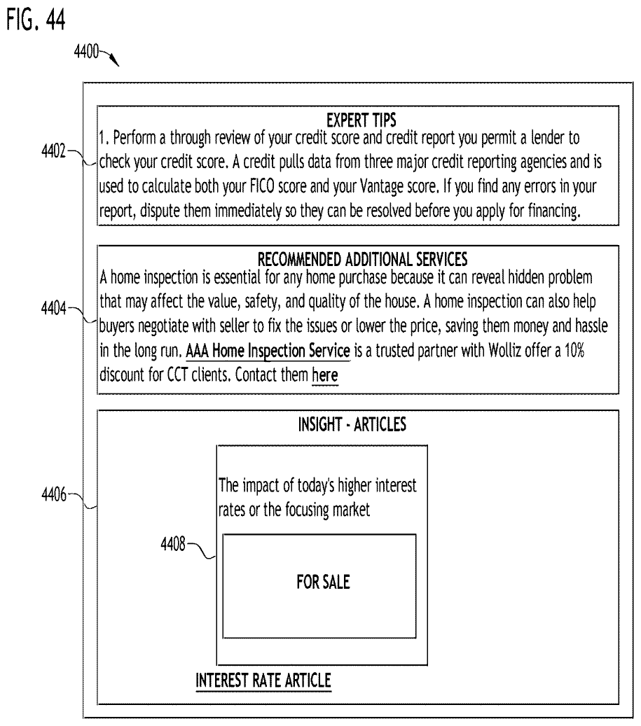

FIG. 44 illustrates an exemplary client report 4400 that includes Expert Tips 4402, Recommended Additional Services 4404, and Insights—Articles 4406, 4408.

### Client Agent Reporting User Interface: Client Agent Report Initiation

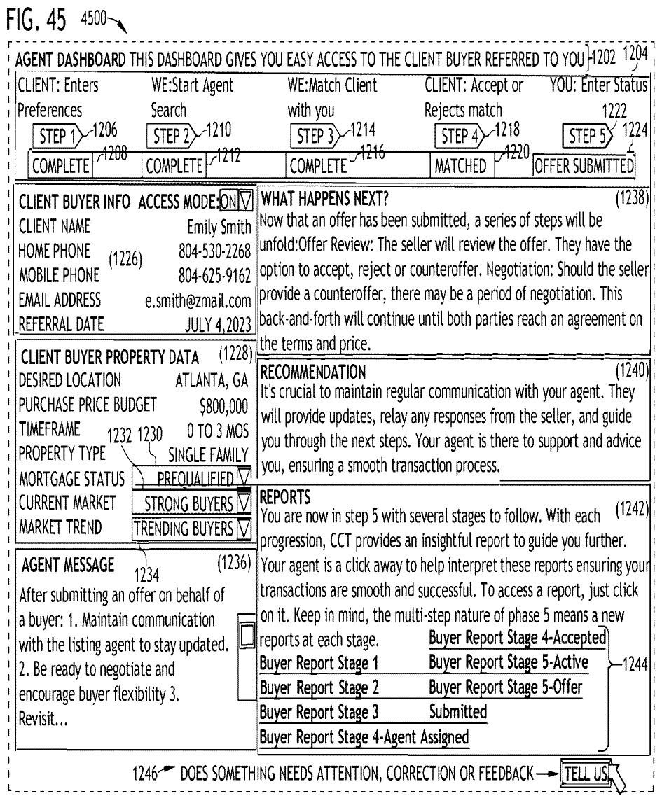

FIG. 45 illustrates an exemplary agent user interface 4500 where the agent has selected a system feedback interface element to report an issue to the system administrator 1246 (arrow).

### Client Agent Reporting User Interface: Client Agent Reporting User Interface

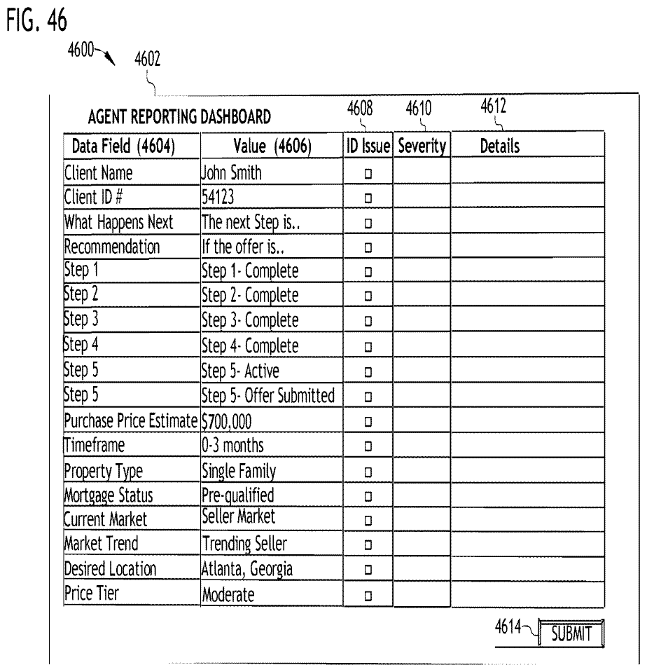

FIG. 46 illustrates an agent reporting user interface 4600 that is presented to an agent who selects the system feedback interface element of FIG. 45. This shows an Agent Reporting Dashboard 4602 with a number of fields

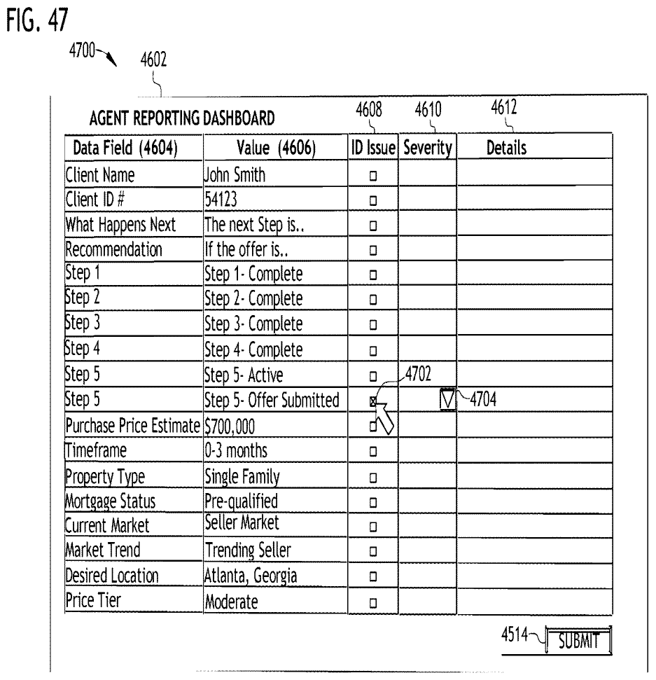

FIG. 47 illustrates the agent reporting user interface 4700 of FIG. 46 wherein the agent user has selected an ID issue corresponding to a data field and value they would like to report 4702 (arrow), 4704.

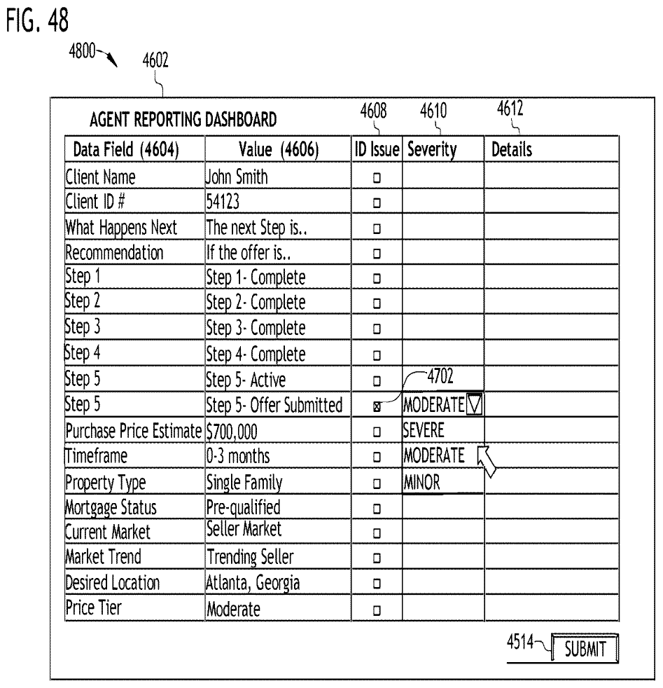

FIG. 48 illustrates the agent reporting user interface 4800 of FIGS. 46-47 wherein the agent user has selected severity value corresponding to a data field and value they would like to report 4702, 4704, 4802 (arrow).

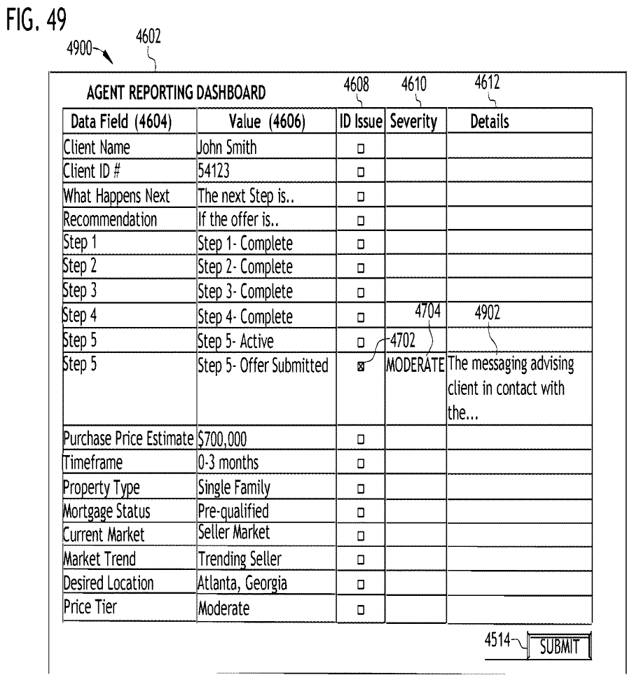

FIG. 49 illustrates the agent reporting user interface 4900 of FIGS. 46-48 wherein the agent user has input freeform details corresponding to a data field and value they would like to report (4702, 4704, 4902) and subsequently selects a submission interface element to submit the report information to the system administrator 4514 (arrow).

### Client Agent Reporting User Interface: System Administrator Report User Interface

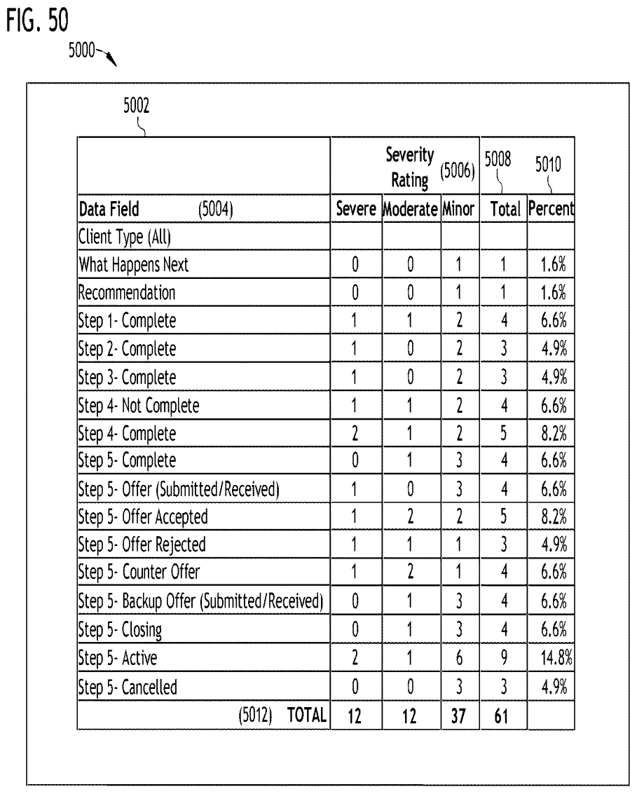

FIG. 50 illustrates a system administrator report user interface 5000 that presents an accumulation of agent feedback for all data fields 5004 in the agent and corresponding buyer client and seller user interfaces.

### Computer System

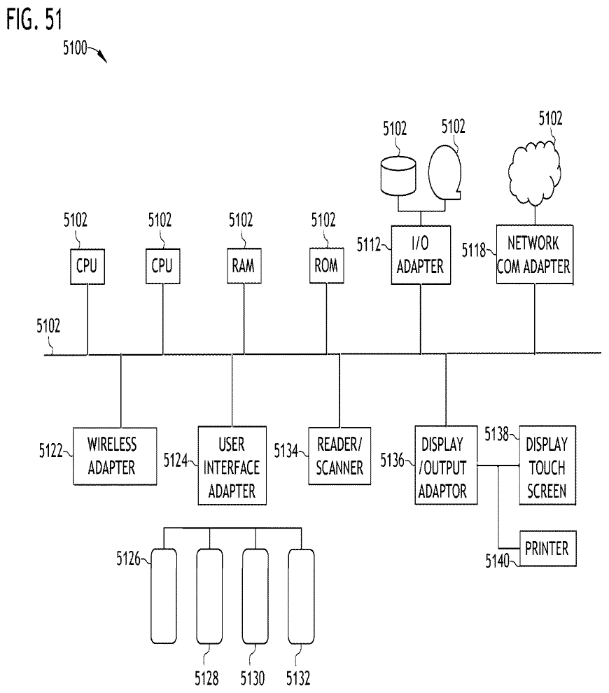

FIG. 51 illustrates an exemplary computer system 5100 configured to support any of the system computational servers of FIG. 1 to enable the methods of the embodiments disclosed herein. Components include a first CPU 5102, a second CPU 5104, RAM 5108, ROM 5110, an I/O Adapter 5112, a Network COM Adapter 5118, a Display/Output Adapter 5136, a Reader/Scanner 5134, a User Interface Adapter 5124, and a Wireless Adapter 5122.

### Exemplary Buyer's Experience

In certain embodiments of this invention, a buyer's experience with the systems and methods of this invention will go far beyond providing a buyer with simply listing information. Instead, the buyer will also obtain valuable directions in navigating the path to owning real estate or other relevant outcome. The buyer starts by entering in information (e.g., FIG. 5; open-access engagement without personal identification). The embodiments of this invention then align the information with market trends and other important facts and presents the buyer with their personalized dashboard (e.g., FIG. 14). That dashboard will contain “What Happens Next”, “Recommendation” and “Reports” sections, in certain embodiments, that will provide the buyer with personalized and relevant directions (e.g., blue prints, roadmaps) on the relevant transaction process and the particular stage the buyer is in. This builds trust, confidence, clarity, accuracy, and competency in the process. An “Expert Tips” section (e.g., explaining mortgage pre-qualified vs. preapproved; explaining bid success; explaining a preapproval letter; explaining credit challenges) is also provided on the “Reports” section of the dashboard, as well as “Tailored (or Additional) Services” (e.g., loans, appraisers, inspectors, movers) and “Insights” (e.g., guidance).

Other parts of the buyer dashboard include “Your Home Search” and recommendations, and market trend information (e.g., trending sellers, trending buyers). The buyer dashboard will also set forth the step in the process the transaction is in.

### Exemplary Seller's Experience

In certain embodiments of this invention, a seller's experience with the systems and methods of this invention provide the seller with valuable directions in navigating the path to selling their real estate or other desired outcome. The seller starts by entering in information (e.g., FIG. 5). The embodiments of this invention then align the information with market trends and other important facts and presents the seller with their personalized dashboard (e.g., FIG. 15). That dashboard will contain “What Happens Next”, “Recommendation” and “Reports” sections, in certain embodiments, that will provide the seller with personalized and relevant directions (e.g., blue prints, roadmaps) on the relevant transaction process and the particular stage the seller is in. This builds trust, confidence, clarity, accuracy, and competency in the process. The seller dashboard will also set forth the step in the process the transaction is in.

### Implementation of AI Systems/Methods

In steps and actions in FIGS. 1-50, and the computer devices of FIG. 51, AI systems and methods can be applied to analyze data and optimize the implementation of one or more of the steps and actions.

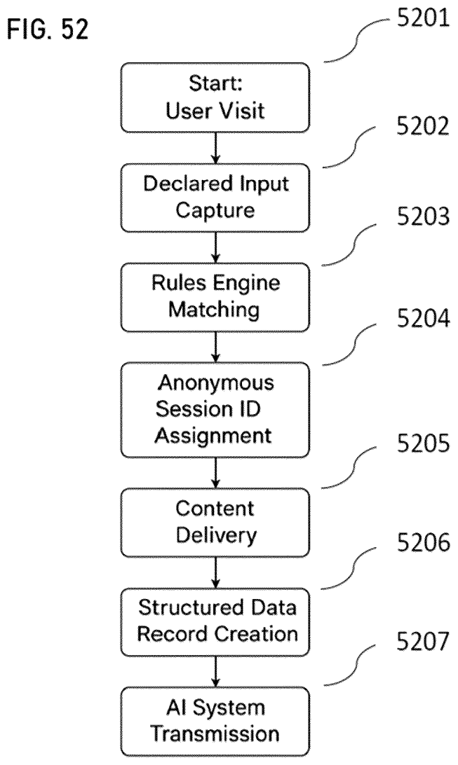

FIG. 52 is a flow diagram that visually represents features of certain illustrative embodiments of systems and methods for capturing declared user input, structuring engagement data, and transmitting the data to AI systems, potentially even before user identity submission. This architecture highlights the deterministic logic, structured data creation, privacy-preserving session handling, and AI model integration with the steps and actions of this invention (e.g., FIGS. 1-51). These preferred embodiments begin with a User Visit: the User accesses an web or app interface (5201) and then different events, in various order, can occur, such as Declared Input Capture: where the User provides scenario-specific input (goals, timeline, budget) (5202); Rules Engine Matching: where the system/method compares input to stored engagement rules (5203); Anonymous Session ID Assignment: where a temporary ID is assigned (5204); Content Delivery: where tailored content sequence is delivered to the user (5205); Structured Data Record Creation: where interaction is logged with timestamps (5206); and AI System Transmission: where structured data is sent to AI for training, even if the user's identity is not captured (5207). In addition, in some embodiments there can be CRM Association (Conditional): where upon identity submission, session data is linked to a user profile. In some embodiments, there can also be a System Feedback Loop (Optional): where AI model output may refine a rules engine.

The structured engagement data captured by certain preferred embodiments of this invention is valuable for both human judgment and AI optimization. Below are two specific, enabled examples showing how the same anonymous, declared-intent data stream fuels human insight and strengthens AI models—without compromising privacy or brand control.

### Human Agent Dashboard Use Example

In these exemplary embodiments, a user visiting a real estate or other relevant website chooses “Get Personalized Advice” or a similar choice without submitting contact information. The user then anonymously declares their desires for real estate or some other relevant outcome, such as a budget ($800,000), location (Atlanta, GA), timeline (6 months), and property type (single-family home). An embodiment of this invention then (a) assigns the user a unique anonymous ID (“User A-001”); and based on deterministic rules, the embodiment matches the user to a curated dashboard with brand-approved resources, such as mortgage calculators, Atlanta neighborhood guides, and moving timeline planners.

The human agents (b) access their dashboard provided by the embodiment and see: “User A-001” interacted with mortgage tools (3 interactions); the user viewed the Buckhead neighborhood guide for 4 minutes; (c) the user downloaded a “6-Month Moving Plan.” Thus, the agent sees clear engagement evidence—but no personal identity information until it is voluntarily submitted. If the user later provides contact information, their entire engagement history links to their CRM profile. A key feature here is that the human agents gain early visibility into user needs and engagement quality, enabling smarter future outreach without guessing.

### AI System Consumption (Training/Optimization Use)

In these exemplary embodiments, the same structured engagement data from “User A-001” from the example above is routed to an AI system connected to the platform. The AI system actions can comprise that the AI system consumes the structured engagement data to: (a) train AI Models: Understanding patterns—e.g., users who interact deeply with mortgage tools tend to be 90% closer to purchase decision; (b) Enhance Scoring Algorithms: Improving lead scoring models based on how deeply users engage and declared needs (budget, location, timeline); (c) Optimize Content Recommendation Engines: Learning which types of curated content drive deeper engagement across anonymous users.; and (d) Predict User Readiness: Using structured interaction depth as a proxy for future lead conversion likelihood.

A key feature here is that the anonymous structured data makes the AI smarter at understanding readiness signals and engagement patterns. In addition, the AI does not control the initial content shown to the user—deterministic logic governs that. Furthermore, instead of controlling the initial content, the AI learns from structured signals to improve future predictions, scoring, routing, and personalization after the fact.

### Preferred Use of Human Agents and AI Systems

In certain preferred embodiments of this invention, human agents are used differently from Ai systems. Human agents use the data to prioritize actions based on observed engagement—no guesswork. AI systems, on the other hand, use the same structured, declared-intent data to get smarter at predicting, scoring, and recommending—but they do not control original content delivery. Thus, in these embodiments, there is a clear division of roles; deterministic logic is used for content matching; and AI is used for learning, optimization, prediction.

### Use of Community Intelligence and Content Not From Algorithms

Certain embodiments of this invention apply “Community Intelligence” and similar origins and concepts of content refers to preferred content that users engage with that is not generated by algorithms. This preferred content is human-created and curated by the user/company, ensuring that it reflects the company's brand, standards, and voice. Because certain of these embodiments use deterministic logic to match users to this predefined content—rather than generating or modifying it through AI—the risk of hallucinations, inconsistencies, or off-brand messaging is reduced or eliminated.

### Flexibility of This Invention to Various Applications

After each update to client transaction step information or user engagement records, preferred embodiments may optionally route corresponding structured engagement data to one or more AI systems for: (a) scoring lead readiness, (b) predicting next-best actions, (c) training predictive models, and/or (d) other uses that will be apparent to a person of skill in the art reading this specification. This orchestrates proactive workflows, based on the declared user inputs and engagement behaviors. Thus, instead of adding new AI-specific branches everywhere in a system or process (or just at the end to feed AI instead of the agent/user), in certain preferred embodiments, after every update or engagement, the structured data can optionally be routed to an AI system for further analysis, scoring, or automation.

An important advantage and feature of certain embodiments of this invention is that they practice flexibility in transaction steps in the following manner: (a) not every engagement will follow the full traditional “accept/reject agent” model; (b) some steps might be skipped, customized, dynamically generated, or bypassed altogether based on the client's needs; (c) the systems and methods of these embodiments should allow the administrator (i.e., the company) to configure which steps are shown to each user type, project type, transaction type, etc. Therefore, dynamic transaction step management and structured AI routing is important in applying embodiments of this invention.

In certain preferred embodiments, the system enables flexible, configurable transaction workflows. Administrators may select, customize, enable, disable, or reorder progressive transaction steps based on the nature of the client engagement, transaction type, regulatory requirements, or organizational preferences.

After each engagement event—including but not limited to initial data submission, intermediate actions, content interactions, or transaction step updates—the system captures structured engagement data and may optionally route this data to: (a) human agents, via dashboard interfaces; and/or (b) AI systems, for purposes such as scoring user readiness, predicting next-best actions, orchestrating personalized workflows, or training machine learning models.

This structured data routing in these embodiments occurs regardless of the specific transaction steps configured, ensuring that both human and machine consumers have continuous access to high-quality, declared-intent engagement data throughout the user's journey.

Thus, in these preferred embodiments, flexible architecture is preferred and the platform is not “hardwired” to a single process like “agent acceptance.” Companies can customize everything, which leads to broad applications in structured engagement platforms, not just real estate or other relevant flow, for example. It also adds future proofing for AI. For example, whether the user submits an offer, skips the agent, or just uses a mortgage calculator, there is still gathering and routing of the structured data. Furthermore, it provides for stronger enforceability because it provides a clean, understandable system and method design that ties human dashboards and AI outputs together without ambiguity. This is more attractive to buyers because they can deploy embodiments of this invention across multiple industries without worrying about real estate-specific (or other relevant) restrictions.

### Applications in Multiple Industries and Uses

Although the description herein uses several real estate examples (e.g., budget, location, home type, mortgage status, timeline) to demonstrate how the systems and methods of this invention operate, embodiments of this invention can be applied across multiple industries, not just real estate. Real estate is simply one example of how embodiments of this invention can be implemented and the user engagement process is adaptable based on the industry by changing the types of questions asked. For instance, in healthcare, a potential patient might instead be asked about symptoms, insurance status, preferred appointment times, location preferences, or medical history. In financial services, users might be asked about investment goals, income range, risk tolerance, or savings targets. The core systems and methods designs of preferred embodiments of this invention—using deterministic logic to map declared user inputs to curated content and capturing structured pre-identity engagement data—remains the same across industries.

It should therefore by understood that any specific examples given herein are non-limiting, and the systems and methods can be adapted to any industry where structured user engagement is valuable. This is implemented with the flexibility features of this invention referenced regarding steps in the process herein.

### Particular Applications to Computer Devices

The system applied to this invention may include a plurality of different computing device types (e.g., FIG. 51). In general, a computing device type may be a computer system or computer server. The computing device may be described in the general context of computer system executable instructions, such as program segments and/or modules, being executed by a computer system (described for example, below). In some embodiments, the computing device may be a cloud computing node (for example, in the role of a computer server) connected to a cloud computing network (not shown). The computing device may be practiced in distributed cloud computing environments where tasks are performed by remote processing devices that are linked through a communications network. In a distributed cloud computing environment, program modules may be located in both local and remote computer system storage media including memory storage devices.

The computing device may typically include a variety of computer system readable media. Such media could be chosen from any available media that is accessible by the computing device, including non-transitory, volatile and non-volatile media, removable and non-removable media. The system memory could include random access memory (RAM) and/or a cache memory. A storage system can be provided for reading from and writing to a non-removable, non-volatile magnetic media device. The system memory may include at least one program product having a set (e.g., at least one) of program modules that are configured to carry out the functions of embodiments of the invention. The program product/utility, having a set (at least one) of program modules, may be stored in the system memory. The program modules generally carry out the functions and/or methodologies of embodiments of the invention as described herein.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects “system.” Furthermore, aspects of the disclosed invention may take the form of a computer program product embodied in one or more computer readable media having computer readable program code embodied thereon.

Aspects of the disclosed invention are described above with reference to flowcharts and block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

### OTHER EMBODIMENTS

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

We claim:

1. An engagement platform that comprises a system for generating and structuring engagement data from a plurality of anonymous user interactions with content that generates declared input data, content engagement behavior, and an associated timestamp, the system comprising:
(a) one or more memory devices that store rule definitions and engagement logic, and
(b) one or more processors that are programmed, the programming comprising one or more modules that (i) receive the declared input data, content engagement behavior, and associated timestamp from each user interaction with content through a graphical interface, the declared input data comprising scenario-specific selections indicating information comprising the user's goals, timeframe, and/or budget; (ii) identify a matched rule set from stored rule definitions corresponding to the declared input data; (iii) assemble a sequence of digital content elements based on the matched rule set; (iv) assign an anonymous session identifier to each user interaction; (v) generate a structured data record comprising the declared input data, content engagement behavior, and associated timestamp data; (vi) store the structured data record in a persistent data store in a format optimized for machine learning ingestion; (vii) transmit the structured data record to an AI model for training and inference, regardless of whether user identity has been captured; (viii) upon receipt of any user identity, associate the structured data record with a corresponding CRM profile using a secure linking mechanism; and (ix) wherein the structured engagement data enables pre-identity personalization, improves the AI model accuracy, and eliminates reliance on behavioral tracking systems, thereby enhancing the functional performance of the engagement platform.

2. The engagement platform of claim 1, wherein the AI model comprises a machine learning model configured to refine engagement recommendations based on aggregated, structured data from multiple anonymous user sessions, thereby enabling intent-aware optimization without requiring identity-based tracking.

3. The engagement platform of claim 1, wherein the engagement platform is selected from the group consisting of customer engagement platforms, student engagement platforms, donor engagement platforms, buyer engagement platforms, employee engagement platforms, community engagement platforms, sales engagement platforms, and real estate engagement platforms.

4. A method for improving artificial intelligence (AI) model performance in an engagement platform using pre-identity user engagement data and the user's stated scenario, and/or need, the user having a known profile, the method comprising:
(a) receiving, via a digital interface, declared input data from the user who has not submitted identifying information;
(b) processing the declared input data using a rules-based engine to determine the user's interaction with a content sequence tailored to the user's stated scenario and/or need to create structured records;
(c) assigning a session-specific anonymous identifier to the user and logging the structured records of the user's interaction with the content sequence to create structured interaction data;
(d) transmitting the structured interaction data, linked only to the anonymous identifier, to an AI model for use in model training or inference, such that the AI model learns from real declared-intent behavior without requiring identity or tracking-based data;
(e) associating the structured interaction data with the user's known profile to enrich CRM records and further refine the AI model upon subsequent user identification; and
(f) wherein the method improves AI model training fidelity and personalization accuracy by enabling access to structured, declarative data captured before traditional lead conversion, without relying on probabilistic behavior tracking or invasive data collection.

5. The method of claim 4, wherein the method comprises the step of aggregating structured interaction data for a plurality of users thereby enabling intent-aware optimization without requiring identity-based tracking.

6. The method of claim 4, wherein the engagement platform is selected from the group consisting of customer engagement platforms, student engagement platforms, donor engagement platforms, buyer engagement platforms, employee engagement platforms, community engagement platforms, sales engagement platforms, and real estate engagement platforms.

7. A method for tracking a plurality of progressive transaction steps in a client transaction comprising:
(a) providing a system application server including memory for storing processor instructions and a processor for executing the processor instructions;
(b) providing a system session server, in communication with the system application server, the system session server configured to establish and maintain a system session with at least one user and generate at least one user interface accessible by the at least one user;
(c) providing a user profile database in communication with the system application server, the user profile database including at least one client profile record including, (i) client personal information comprising open-access engagement tools and an anonymized data tracking code, (ii) client interest information, and (iii) client transaction step information corresponding to one of a plurality of progressive transaction steps in the client transaction;
(d) providing a client user interface via the system session server configured to display (i) the client personal information, (b) the client interest information, and (iii) a plurality of transaction step indicia, wherein each of the plurality of transaction step indicia corresponds to the plurality of progressive transaction steps in the client transaction;
(e) updating the client transaction step information in the client profile record to a subsequent client transaction step information corresponding to another one of the plurality of progressive transaction steps in the client transaction based on receiving one of (i) a system administration update, (ii) a client update via the client user interface, or (iii) a client agent update; and
(f) updating the client user interface corresponding to updated subsequent client transaction step information by activating a corresponding one of the plurality of transaction step indicia in the client user interface.

8. The method of claim 7, wherein the transaction is a real estate transaction.

9. The method of claim 7, wherein the method is applied to an engagement platform that is selected from the group consisting of customer engagement platforms, student engagement platforms, donor engagement platforms, buyer engagement platforms, employee engagement platforms, community engagement platforms, sales engagement platforms, and real estate engagement platforms.

10. The method of claim 7, wherein the method is applied to an engagement platform and the method further comprises generating client structured engagement data from client interest information and using it with the client agent and/or an AI agent.

11. The method of claim 10, wherein the client structured engagement data is generated before the client provides the client's identification information.
The method of claim 7, wherein the client interest information comprises client buyer interest information including client buyer target interest criteria.

12. The method of claim 7, wherein the client interest information comprises client seller interest information.

13. The method of claim 7, wherein the client transaction step information further includes one of:
a proposed client agent notification;
a client acceptance of a system-proposed client agent;
a client rejection of a system-proposed client agent;
a matched client agent notification;
an offer submission notification;
an offer received notification;
a backup offer submission notification;
a backup offer received notification;
a rejected offer notification;
a counteroffer submission notification;
a counteroffer received notification; or
an accepted offer notification.

14. The method of claim 7, wherein the plurality of transaction step indicia further includes one of:
a proposed client agent notification indicium;
a client acceptance of a system-proposed client agent indicium;
a client rejection of a system-proposed client agent indicium;
a matched client agent indicium;
an offer submission indicium;
an offer received indicium;
a backup offer submission indicium;
a backup offer received indicium;
a rejected offer indicium;
a counteroffer submission indicium;
a counteroffer received indicium; or
an accepted offer indicium.

15. The method of claim 7, wherein the system administration update corresponds to a process of matching a client agent to conduct the client transaction for a client.

16. The method of claim 7, wherein the client update corresponds to one of a client's rejection or a client's acceptance of a system-proposed client agent to conduct the client transaction for a client.

17. The method of claim 7, wherein the client agent update corresponds to one of the plurality of progressive transaction steps of the client transaction.

18. A method for tracking a plurality of progressive transaction steps in a client transaction comprising:
(a) providing a system application server including a memory for storing processor instructions and a processor for executing the processor instructions;
(b) providing a system session server, in communication with the system application server, the system session server configured to establish and maintain a system session with at least one user and generate at least one user interface accessible by the at least one user;
(c) providing a user profile database, in communication with the system application server, the user profile database including at least one client profile record including (i) client personal information comprising open-access engagement tools and an anonymized data tracking code, (ii) client interest information, and (iii) client transaction step information corresponding to one of a plurality of progressive transaction steps in a client transaction;
(d) providing a client agent user interface configured to display (i) the client personal information, (ii) the client interest information, and (iii) a plurality of transaction step indicia, wherein each of plurality of transaction step indicia corresponds to the plurality of progressive transaction steps in the client transaction;
(e) updating the client transaction step information in the client profile record to a subsequent client transaction step information corresponding to another one of the plurality of progressive transaction steps in the client transaction based on receiving a client agent update via the client agent user interface; and
(f) updating the client agent user interface corresponding to the subsequent client transaction step information by activating a corresponding one of the plurality of transaction step indicia in the client agent user interface.

19. The method of claim 18, wherein the transaction is a real estate transaction

20. The method of claim 18, wherein the method is applied to an engagement platform that is selected from the group consisting of customer engagement platforms, student engagement platforms, donor engagement platforms, buyer engagement platforms, employee engagement platforms, community engagement platforms, sales engagement platforms, and real estate engagement platforms.

21. The method of claim 18, wherein the method is applied to an engagement platform and the method further comprises generating client structured engagement data from client interest information and using it with the client agent and/or an AI agent.

22. The method of claim 21, wherein the client structured engagement data is generated before the client provides the client's identification information.

23. The method of claim 18, wherein the client interest information comprises client buyer property information including client buyer target property criteria.

24. The method of claim 18, wherein the client interest information comprises client seller property information.

25. The method of claim 18, wherein the client transaction step information further includes one of:
a proposed client agent notification;
a client acceptance of a system-proposed client agent;
a client rejection of a system-proposed client agent;
a matched client agent notification;
an offer submission notification;
an offer received notification;
a backup offer submission notification;
a backup offer received notification;
a rejected offer notification;
a counteroffer submission notification;
a counteroffer received notification; or
an accepted offer notification.

26. The method of claim 18, wherein the plurality of transaction step indicia further includes one of:
a proposed client agent notification indicium;
a client acceptance of a system-proposed client agent indicium;
a client rejection of a system-proposed client agent indicium;
a matched client agent indicium;
an offer submission indicium;
an offer received indicium;
a backup offer submission indicium;
a backup offer received indicium;
a rejected offer indicium;
a counteroffer submission indicium;
a counteroffer received indicium; or
an accepted offer indicium.

27. The method of claim 18, wherein the client agent update corresponds to one of the plurality of progressive transaction steps of the client transaction.

28. A system for tracking a plurality of progressive transaction steps in a client transaction, the system comprising:
(a) a system application server including a memory for storing processor instructions and a processor for executing the processor instructions which when executed are configured to at least one of communicate with and control:
(i) a system session server configured to establish and maintain a system session with at least one user and generate at least one user interface accessible by the at least one user; and
(ii) a user profile database configured to store and update user profile records including a client profile record including (1) client personal information comprising open-access engagement tools and an anonymized data tracking code, (2) client interest information, and (3) client transaction step information corresponding to one of a plurality of progressive transaction steps in a client transaction;
(b) wherein the system is configured to:
(i) provide, by the system session server, a client user interface and a client agent user interface both configured to display (1) the client personal information, (2) the client interest information, and (3) a plurality of transaction step indicia, wherein each of the plurality of transaction step indicia corresponds to the plurality of progressive transaction steps in the client transaction;
(ii) update, in the user profile database, the client transaction step information in the client profile record to a subsequent client transaction step information corresponding to another one of the plurality of progressive transaction steps in the client transaction based on receiving one of (1) a system administration update, (2) a client update via the client user interface, or (3) a client agent update via the client agent user interface; and
(c) update, by the system session server, the client user interface and the client agent user interface corresponding to the subsequent client transaction step information by activating a corresponding one of the plurality of transaction step indicia in the client agent user interface.

29. The system of claim 28, wherein the transaction is a real estate transaction

30. The system of claim 28, wherein the system is applied to an engagement platform that is selected from the group consisting of customer engagement platforms, student engagement platforms, donor engagement platforms, buyer engagement platforms, employee engagement platforms, community engagement platforms, sales engagement platforms, and real estate engagement platforms.

31. The system of claim 28, wherein the system is applied to an engagement platform and the system further comprises a step of generating client structured engagement data from client interest information and using it with the client agent and/or an AI agent.

32. The system of claim 31, wherein the client structured engagement data is generated before the client provides the client's identification information

33. The system of claim 28, wherein the client interest information comprises client buyer property information including client buyer target property criteria.

34. The system of claim 28, wherein the client interest information comprises client seller property information.

35. The system of claim 28, wherein the client transaction step information further includes one of:
a proposed client agent notification;
a client acceptance of a system-proposed client agent;
a client rejection of a system-proposed client agent;
a matched client agent notification;
an offer submission notification;
an offer received notification;
a backup offer submission notification;
a backup offer received notification;
a rejected offer notification;
a counteroffer submission notification;
a counteroffer received notification; or
an accepted offer notification.

36. The system of claim 28, wherein the plurality of transaction step indicia further includes one of:
a proposed client agent notification indicium;
a client acceptance of a system-proposed client agent indicium;
a client rejection of a system-proposed client agent indicium;
a matched client agent indicium; an offer submission indicium;
an offer received indicium;
a backup offer submission indicium;
a backup offer received indicium;
a rejected offer indicium;
a counteroffer submission indicium; a counteroffer received indicium; or
an accepted offer indicium.

37. The system of claim 28, wherein the system administration update corresponds to a process of matching a client agent to conduct the client transaction for a client.

38. The system of claim 28, wherein the client update corresponds to one of a client's rejection or acceptance of a system-proposed client agent to conduct the client transaction for a client.

39. The system of claim 28, wherein the client agent update corresponds to one of the plurality of progressive transaction steps of the client transaction.
